(19) United States
(12) Patent Application Publication
(10) Pub. No.: US 2009/0187486 A1
(43) Pub. Date: Jul. 23, 2009

(54) METHOD AND APPARATUS FOR DELIVERING TARGETED CONTENT

(76) Inventors: Michael LEFENFELD, New York, NY (US); Randall DAVIS, Bethesda, MD (US)

Correspondence Address: NIXON PEABODY, LLP, 401 9TH STREET, NW, SUITE 900, WASHINGTON, DC, 20004-2128, US

(21) Appl. No.: 12/355,452

(22) Filed: Jan. 16, 2009

Related U.S. Application Data
(60) Provisional application No. 61/022,311, filed on Jan. 18, 2008.

(51) Int. Cl. G06Q 30/00; G06F 17/30

(52) U.S. Cl. 705/14; 707/104.1; 705/1; 707/E17.044

(57) ABSTRACT

Embodiments of the present invention permit a user to receive content that is directly targeted to that particular user's interests, including a method for targeting content that is arranged on a page that is displayable by a computing device, including the steps of displaying a list of categories of available advertising content, wherein the available advertising content is stored in a database, receiving a selection of at least one of the categories of the advertising content from a user, selecting advertising content from the database that corresponds to the selection of categories received from the user, and transmitting a page including the selected advertising content to a computing device for display on the computing device. In addition, embodiments of the present invention allow the tracking of content from when it is initially shared, to when revenue is generated based on an action of a user on the shared content portion.

### CLAIM OF BENEFIT AND INCORPORATION BY REFERENCE

This application claims priority to previously-filed U.S. Provisional Patent Application No. 61/022,311 to LEFENFELD et al., filed Jan. 18, 2008, entitled “ELECTRONIC ADVERTISING SYSTEM”, the entire disclosure of which is incorporated by reference herein.

### BACKGROUND OF THE INVENTION

1. Field of the Invention

The invention relates to a method and system for targeting content, and more specifically for targeting the advertisements that are received on a network such as the Internet. The invention also relates to a method and system for tracking who initiates an advertisement's distribution through a social network.

2. Description of Related Art

Many Internet content sites are supported by an advertising based revenue model. As known and appreciated in the art, Internet users of all generations, most dominantly Millennials (i.e., those born from 1977-1998) and Generation Xers (i.e., those born from 1965-1976), in fact, do find value in Internet advertising. The vast majority of Internet users purchase products based at least in part upon Internet advertising or through untraced electronic word-of-mouth (e.g., email, instant messages, blogs, etc.), which is evidenced by the fact that the extent of the Internet advertising investment continues to grow at a rapid pace. However, as more advertisers move from traditional media to the Internet to promote their wares, those advertisers may find that there is a limited amount of relevant Internet real estate available for the abundance of advertising that advertisers which to publish. This has forced advertisers to advertise in ways that are not relevant to and not desired by the consumer. The result is that advertisements are often ineffectual.

Blocking advertisements can be a response to oversaturation of the Internet user community with undesired and poorly-targeted advertising that may cause users to seek the ability to block, or remove, advertisements from their web experience. For example, a version of the AdBlock™ browser extension, in existence as of the date of this document, can remove advertisements from a webpage and readjust the webpage's layout to appear as if the advertisements had never existed.

Technological solutions capable of removing advertisements from their ordinary and intended placements on viewed web pages can have been used as responses to oversaturation of undesired or non-specific advertising to which users have been subjected. However, wholesale blocking of advertisements may be considered too extreme a technique to deal with perceived advertisement oversaturation. In some cases when ad blocking has a significant financial impact on a website, the sponsors or owners of the website may consider changing revenue models, such as a subscription or other paid access model, to be able to continue to generate revenue.

“Targeted” advertising, wherein data about the user is collected to determine advertisements that are relevant to the user, has become popular. For instance, U.S. Pat. Pub No.: 2002/0010757 A1 discloses an Ad Replacer application, which is downloaded by a user as a browser plug-in to filter out unwanted advertisement content, and insert “desired” advertisement content in its place. To determine which advertisement content the user is most likely to have interest, U.S. Pat. Pub. No.: 2002/0010757 A1 contemplates monitoring the user's web browser viewing habits, and web browser navigation data as gathered by the system. This is often accomplished using Web bugs, such as spy-ware and ad-ware, which are contained in downloaded web pages, and are used to secretly monitor key strokes of the user, as well as the web pages the user visits. Furthermore, some search engines collect search terms that a user enters, in an attempt to match ads of interest to a particular user. However, the collection of user activities and other information, and is used to guess which type of advertisements are of interest to users as described by U.S. Pat. Pub. No.: 2002/0010757 A1, raises many privacy concerns.

In an attempt to circumvent the privacy issue, U.S. Pat. Pub. No.: 2007/0204223 A1 teaches that content providers may allow a user to “opt in” to a service that collects general demographic information (e.g., age, sex, race, location, etc.) about or associated with the user. The content provider then uses this general demographic information in conjunction with complex algorithms in an attempt to determine which advertisements the user desires exposure to. However, the method described in U.S. Pat. Pub. No.: 2007/0204223 A1 is ineffectual for a host of reasons. For instance, the algorithm may suggest advertisement content that the content provider does not have, and thus cannot present to the user.

Moreover, both U.S. Pat. Pub. No.: 2002/0010757 A1 and U.S. Pat. Pub. No.: 2007/0204223 A1 additionally suggest that content providers award an incentive to users who click through or view the advertising content, in an attempt to entice users into viewing ads. However, this scheme greatly devalues advertisements, since advertisers have no way of knowing if a user has any real interest in the subject of the advertisement, or if the user merely wishes to receive some sort of incentive. Consequently, the method of rewarding users for viewing ads, as taught by U.S. Pat. Pub. No.: 2002/0010757 A1 and U.S. Pat. Pub. No.: 2007/0204223 A1 is inutile, and actually has a negative impact on the advertising industry.

Additionally, sharing content over a “social network” has also become increasingly popular. U.S. Pat. Pub. No.: 2006/0218577 A1 discloses a conventional method of distributing advertisements with one or more other persons on a user's social network.

Furthermore, when a user seeks content portions or information related to products or services by entering a keyword(s) in a search field of a search engine, the search engine's software program then utilizes complex algorithmic functions and criteria to find keyword matches in the information stored in the index in a known manner. However, the result of the search is often not directed to the specific interest of the user for various reasons. For instance, entering the correct keywords in the correct order to obtain content directed to the desired product, service or topic is a somewhat esoteric skill unmastered by most users. Additionally, content providers may have special arrangements to have the search engine web page to be displayed as a result of the search, although maybe unrelated to the search.

### SUMMARY OF THE INVENTION

The present invention facilitates the targeting of content that is arranged on a page that is displayable by a computing device. Accordingly, the invention permits a user to receive content that is directly targeted to that particular user's interests and needs. In addition, the present invention permits the tracking of content from when it is initially shared, to when revenue is generated based on an action of a user on the shared content portion.

Embodiments of the present invention relate to a method for targeting content that is arranged on a page that is displayable by a computing device, including the steps of displaying a list of categories of available advertising content, wherein the available advertising content is stored in a database, receiving a selection of at least one of the categories of the advertising content from a user, selecting advertising content from the database that corresponds to the selection of categories received from the user, and transmitting a page including the selected advertising content to a computing device for display on the computing device.

The embodiments of the present invention also relate to a system for targeting content that is arranged on a page that is displayable by a computing device, including means for displaying a list of categories of available advertising content, wherein the available advertising content is stored in a database, means for receiving a selection of at least one of the categories of the advertising content from a user, means for selecting advertising content from the database that corresponds to the selection of categories received from the user, and means for transmitting a page including the selected advertising content to a computing device for display on the computing device.

Furthermore, the embodiments of the present invention relate to a method of peer-to-peer sharing of content portions of a page displayed on a user computing device, wherein the peer-to-peer sharing occurs on a social network platform, including the steps of displaying at least one content portion on a page displayed on a first user device, receiving a request from the first user to share at least one content portion with at least one second user, sharing the content portion with the second user by sending the content portion to a second user device, tracking and storing information about the shared content in a profile that is stored in a database after the content portion is shared with the second user, wherein the profile is associated with the first user, and detecting generation of revenue based on an action of the second user on the content portion.

In addition, the embodiments of the present invention relate to system for peer-to-peer sharing of content portions of a page displayed on a user computing device, wherein the peer-to-peer sharing occurs on a social network platform, including means for displaying at least one content portion on a page displayed on a first user device, means for receiving a request from the first user to share at least one content portion with at least one second user, means for sharing the content portion with the second user by sending the content portion to a second user device, means for tracking and storing information about the shared content in a profile that is stored in a database after the content portion is shared with the second user, wherein the profile is associated with the first user, and means for detecting generation of revenue based on an action of the second user on the content portion.

The method for targeting content that is arranged on a page that is displayable by a computing device may include reviewing the advertising content stored in the database, determining categories of the advertising content, and creating a list of the categories, wherein the categories are organized in a schema, wherein the list of categories include a checkbox for each category in the list, wherein the list of categories includes subcategories, wherein the page includes a webpage, wherein the categories include topics of the advertising content, wherein the categories include the type of the advertising content, wherein the topics of the advertising content include at least one of sports, automobiles, clothing, promotional material, accessories, food, alcoholic beverages, furniture, animals, travel, vacations, merchandise, equipment, loans, credit cards, news, weather and adult content, wherein the type of advertising content includes text, pictures, audio files, references to audio streams, and video, displaying a safety rating associated with the available advertising content, and receiving a selection of a safety rating from the user, wherein the safety rating displayed is a slide scale, and wherein age is taken into account by the safety rating.

The system for targeting content that is arranged on a page that is displayable by a computing device may include means for reviewing the advertising content stored in the database, means for determining categories of the advertising content, and means for creating a list of the categories, wherein the categories are organized in a schema, wherein the list of categories include a checkbox for each category in the list, wherein the list of categories includes subcategories, wherein the page includes a webpage, wherein the categories include topics of the advertising content, wherein the categories include the type of the advertising content, wherein the topics of the advertising content include at least one of s ports, automobiles, clothing, promotional material, coupons, accessories, food, alcoholic beverages, furniture, animals, travel, vacations, merchandise, equipment, loans, credit cards, news, weather and adult content, wherein the type of advertising content includes promotional material, text, pictures, audio files, references to audio streams, and video, means for displaying a safety rating associated with the available advertising content, means for receiving a selection of a safety rating from the user, wherein the safety rating displayed is a slide scale, and wherein age is taken into account by the safety rating.

The method of peer-to-peer sharing of content portions of a page displayed on a user computing device, wherein the peer-to-peer sharing occurs on a social network platform may include that the second user is selected from a list, wherein the list is a predetermined list, that the content portions are at least one of an advertisement, a coupon, a picture, a text or media, that the second user's user device receives the content portions through at least one of email, a text message, a picture message, an instant message, a host website and an automated voice call, receiving a request from the first user to attach a map to the content portion, attaching a map to the content portion, wherein the map is related to the content portion, wherein the second user is able to interact with the shared content portion to retrieve a map related to the content portion, wherein the second user is able to interact with the shared content portion to retrieve consumer information related to the shared content portion, issuing a higher billing rate to an advertiser associated with the content portion in response to the generation of revenue, receiving information related to the location the second user and the content portion, issuing a map to the second user based on the location of the second user, wherein the second user is the first user, and the second user device is a mobile device of the first user, wherein the content portion is a coupon, wherein the second user has a predefined relationship on the social network with the first user, and issuing a commission to the first user in response to the generation of revenue.

The system for peer-to-peer sharing of content portions of a page displayed on a user computing device, wherein the peer-to-peer sharing occurs on a social network platform may include wherein the second user is selected from a list, wherein the list is a predetermined list, wherein the content portions are at least one of an advertisement, a coupon, a picture, a text or media, wherein the second user's user device receives the content portions through at least one of email, a text message, a picture message, an instant message, a host website and an automated voice call, means for receiving a request from the first user to attach a map to the content portion, means for attaching a map to the content portion, wherein the map is related to the content portion, wherein the second user is able to interact with the shared content portion to retrieve a map related to the content portion, wherein the second user is able to interact with the shared content portion to retrieve consumer information related to the shared content portion, means for issuing a higher billing rate to an advertiser associated with the content portion in response to the generation of revenue, means for receiving information related to the location the second user and the content portion, means for issuing a map to the second user based on the location of the second user, wherein the second user is the first user, and the second user device is a mobile device of the first user, wherein the content portion is a coupon, wherein the second user has a predefined relationship on the social network with the first user, and means for issuing a commission to the first user in response to the generation of revenue.

### BRIEF DESCRIPTION OF THE DRAWINGS

The invention is described through a preferred embodiment and the attached drawing in which:

FIG. 1 is a block diagram of a computer architecture in accordance with an embodiment of the invention including a search engine server;

FIG. 2 is a block diagram having various devices as nodes of an embodiment;

FIG. 3 is a system block diagram of an embodiment of a client swapping environment;

FIG. 4 is a system block diagram of an embodiment of a client extension;

FIG. 5 is a system block diagram of an embodiment of a client extension;

FIG. 6 is a system block diagram of an embodiment of a client extension;

FIG. 7 is a flow diagram of a method of operation of an embodiment of a client extension;

FIG. 8A is a system block diagram of an embodiment of a client extension;

FIG. 8B is a system block diagram of an embodiment of a client extension;

FIG. 8C is a system block diagram of an embodiment of a client extension;

FIG. 8D is a system block diagram of an embodiment of a client extension;

FIG. 9 is a system block diagram of an embodiment of server-side components;

FIG. 10 is a flow diagram depicting steps in a method for rendering a web page;

FIG. 11 is a flow diagram depicting steps in a method for removing/blocking content portions;

FIG. 12 is a flow diagram depicting steps in a method for swapping ads;

FIG. 13 is a flow diagram depicting steps in a method swapping ad content;

FIG. 14 is a flow diagram depicting steps in a method for adding content portions requests;

FIG. 15 is a flow diagram illustrating the steps of sharing content portions from a page displayed on a device of a first user with a second user;

FIG. 16 is a flow diagram depicting steps in a method of sharing content portions from a page, with an associated map attached thereto, displayed on a device of a first user with a second user;

FIG. 17 is a flow diagram illustrating the steps in a method for removing undesired original content portions, and in its place insert substitute content portions;

FIG. 18 is a flow diagram depicting the steps in a method for replacing original content portions with generated substitute content portions on a page;

FIG. 19 is a flow diagram depicting the steps in a method for replacing original content portions with replacement content portions on a page;

FIG. 20 is a flow diagram depicting the steps in a method for replacing original content portions with replacement content portions on page;

FIG. 21 is a flow diagram depicting the steps in a method of passive searching;

FIG. 22 is a flow diagram depicting the steps in a method for targeting content that is arranged on a page that is displayable by a computing device; and

FIG. 23 is a flow diagram depicting the steps in a method of peer-to-peer sharing of content portions of a page displayed on a user computing device.

### DETAILED DESCRIPTION OF THE PREFERRED EMBODIMENT

The collection of general demographic information and processing by complex algorithms, as contemplated by the prior art, leaves too much “guess-work” on behalf of the user regarding the receipt of specific advertisements that the user wishes to receive. Moreover, the prior art is completely silent with regard to tracking electronic “word-of-mouth” sales. Applicants have discovered a unique means to remove the “guess-work” required by the user in receiving advertising content, thus facilitating the receipt of specific advertising content that the user desires exposure to. In addition, Applicants have discovered an advertising model that is able to leverage social relationships developed online, by enabling the electronic “word-of-mouth” sales through a social platform, by tracking who initiates an advertisement's distribution through a social network.

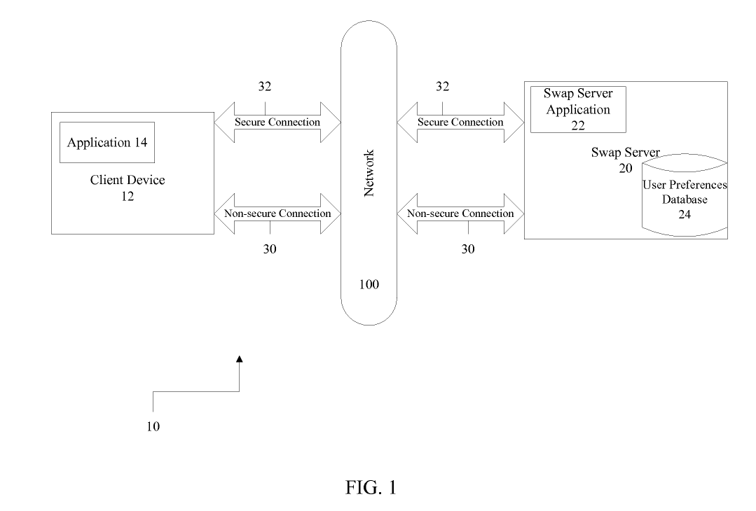

A preferred embodiment of a computer architecture of the invention is illustrated in FIG. 1. Swap system 10 includes client device 12, which executes application 14 that supports the appropriate protocol, for instance an HTTP protocol. Client device 12 is connected, typically through an ISP (Internet Service Provider) to network 100, serving as a communications channel. Although use of such networks as the Internet, telecommunication networks such as asynchronous transfer mode (ATM) networks, wireless cellular networks including code division multiple access (CDMA), time division multiple access (TDMA), global system for mobile communications (GSM), and 3G protocols, as well as other wired and wireless networks are contemplated, those of ordinary skill in the art will readily recognize that a wide variety of communication options are available. Swap system 10 is capable of swapping content portions, such as portions of a web page, to provide content portions of specific interest to the user.

For example, client computer 12 can be coupled to the ISP through a broadband connection such as ISDN (Integrated Services Digital Network), a cable modem, a DSL (Digital Subscriber Line) connection, or a wireless connection. Swap server 20 is also coupled to the Network 100 in a known manner. Swap server 20 executes, for example, a swap server control application 22, such as an HTTP server application, stored in a memory device. For instance, public domain web server software applications from NCSA or APACHE can be used.

In the preferred embodiment, both of the client device 12 and the swap server 20 can be capable of communicating using a secure connection protocol, such as SSL or S-HTTP. For clarity, non-secure connections 30 and secure connections 32 are illustrated separately. However, typically, these connections will be effected over the same physical connection or communication channel, such as the Internet (i.e., Network 100). Further, swap server 20 can have records of many different user preferences stored therein, and the user preferences can be in the form of an index. Swap server 20 also includes user preferences database 24 stored in the memory device thereof as described in detail below. As will become clear below, each of the client device 12 and the swap server 20 can be multiple devices.

Client device 12 can request a display of a page, e.g., a web page, from swap server 20 or another server, by issuing a URL request through network 100 to swap server 20 or another server. The page is made up of plural content portions. The user can request and navigate to a page in a known manner. User preferences database 24 can include records of user preferences, e.g., specific advertisements of interest to the user, among other things, that the user is exposed to throughout the duration of a search. For example, user preference database 24 can be an index of user preferences. The index of user preferences should be updated periodically to keep information on the most current topics of interest to the user included in the user preference database 24. The user preferences stored in the user preference database 24 can be updated statically or dynamically. In one embodiment, content having content portions, such as a web page, will be retrieved for display on the client device 12. However, instead of displaying the retrieved web page, certain portions of the web page can be blocked and/or replaced with substitute content portions selected based on the user preferences.

Thus, the web page is transformed by blocking and/or replacing the HTML code associated with certain content portions of the web page, and in place of the blocked and/or replaced HTML code, inserting HTML code associated with substitute content portions selected based on the user preferences. Thus, transforming the physical entity of the web page.

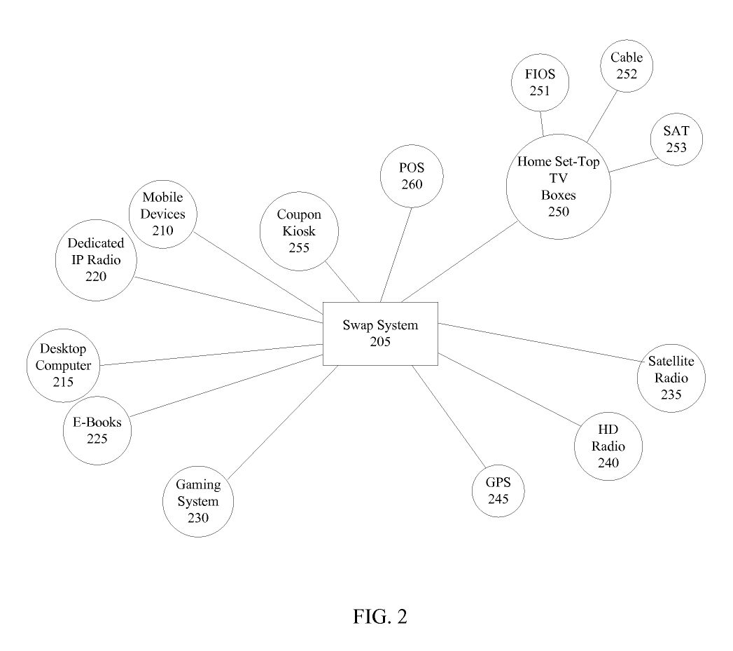

As seen in FIG. 2, a variety of client devices 12 can connect to the swap system 205, including a variety of mobile computing devices. It should be recognized that depending upon the functionality and capabilities of each device connected to the swap server 20, the specific type and format of information to be swapped can and will vary. The client device 12 can include mobile devices 210, such as laptop and palmtop computers, personal digital assistants (PDAs), cellular telephones, and portable media players, among other devices. The swap server 20 can also connect to a desktop computer 215 or a dedicated Internet Protocol (IP) radio 220. The IP radio 220 can be a standalone device, a software-defined radio running on a computer, or a media player capable of supporting Internet radio functionality. In addition, an electronic book 225 may also connect to the swap server 20.

A gaming system 230 is another client device 12 that can connect to the swap server 20. The various types of gaming systems 230 that can be used as the gaming system 230 include standalone gaming consoles, as well as those that can support online games, including massively multiplayer online games. With regard to gaming devices 230, the swap server 20 can provide content portions that can be displayed in games such as in-gaming advertising and other in-world or in-game items.

Yet another type of device that can connect to the swap server 20 is a satellite radio 235. Satellite radios 235 can receive broadcast signals from one or more satellites orbiting the Earth in geosynchronous orbits. Such a satellite radio 235 can also be addressable. Similarly, a high-definition (HD) 240 or digital radio can connect to the swap server 20. The HD radio 240 or digital radio can also be addressable.

A Global Positioning System (GPS) 245 is another device that can connect to the swap server 20. GPS systems 245 can calculate its position by carefully timing the signals sent by the GPS satellites high above the Earth.

A set-top television box (STTB) 250 can also connect to the swap server 20 using a variety of suitable physical or wireless networking systems. Among those networking systems are included a fiber optic (FIOS) network 251, a cable network 252, and a satellite network 253. The STTB 250 can also be addressable and configured for 2-way or multi-way (e.g., broadcast) connections with other network nodes.

Furthermore, a coupon kiosk 255 can connect to the swap server 20. The coupon kiosk 255 can be implemented as a stand-alone kiosk or another type of coupon vending device, including devices that vend electronic coupons of various types and devices that vend physical coupons. A point-of-sale (POS) system 260, which can also connect to the swap server 20, can be implemented as any of a number of POS systems 260 for retail or wholesale use. The POS system 260 can connect to a variety of inventory, ordering, accounting, or other suitable systems which are not shown and can support coupons of a variety of types, including coupons dispensed or used by the coupon kiosk 255.

In one mode of operation, the electronic information swap network 100 can function as follows. Each client device 12 connected as a node to the electronic information swap network 100 can send and receive electronic information using suitable network protocols. It should be noted that a mixed network, such as the Internet, may be used to interconnect the nodes and that a variety of protocols and internetworking techniques may be needed to interconnect one or more nodes to other nodes in the network.

Each connected node can also support communications from the swap server 20 to permit exchange of content portions. Such support can come in the form of hardware, firmware, or software. For ease of description, components that provide function support for interaction with or through the swap system 10 are referred to generally as client software. However, it should be noted that the use of the term “client” in this context does not describe or imply that a client-server architecture is required to implement the electronic information swap network 100. To the contrary, other suitable architectures can be used, specifically including a peer-to-peer (P2P) architecture, among others. Various functionality can be incorporated into client device 12 through extension which can be in the form of software and/or hardware including computer executable instructions.

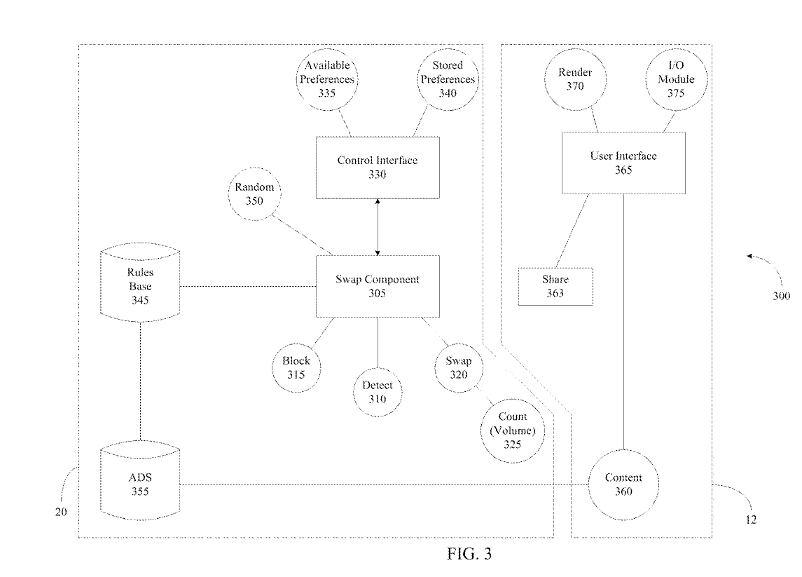

FIG. 3 is a system block diagram of a content swapping environment 300 showing swap server 20 and client device 12 in more detail. The content swapping environment 300 includes a swap component 305. The swap component 305 can be implemented in a client-server architecture, as well as in other suitable architectures, and can support certain core functions. For example, the swap component 305 can support or provide a detection function 310, a block function 315, and a swap function 320. The swap function 320 includes a count subfunction 325 that can be used to monitor, measure, or control the volume of content portions that are swapped.

The swap component 305 can be configured through the use of a control interface 330. The control interface 330 can access a set of available preferences 335 and present the set of available preferences 335 to a user as a selectable list or in another suitable or desired format. Preferences selected by a user can be saved as a set of stored preferences 340. Additionally or alternatively, the set of stored preferences 340 can include default preferences and mandatory preferences. Such mandatory preferences can be pre-selected as needed or desired in a specific implementation or in accordance with some policy set by an administrator or other control entity.

The swap component 305 can provide the user the option to “opt-in”, and expressly choose which type of content portions (e.g., advertisements) the user is exposed to, while searching the Internet, for example. Allowing the user to “opt-in” and expressly choose which type(s) of content portions the user receives, obviates any “privacy” concerns connected with monitoring the user's online activity to determine which type of content portions the user most likely will find beneficial, since the user expressly chooses the content portions that he or she will receive.

For instance, while searching the Internet or viewing a web page, the user can receive a prompt that allows the user to select which topics of interest and the type of content portions that the user prefers exposure to while searching the Internet, and thus these “substitute content portions” will be inserted into web pages in place of the “original content portions”, e.g., advertisements. The prompt can include a list of check boxes specifying the topics and/or type of content portions that will presented to the user. In addition, the prompt can include a space for the user to directly type and/or write in the topics and/or type of content portions that the user wishes to receive. The topics and type of content portions will be described in greater detail below.

The topics of the content portions may include sports, automobiles, clothing, promotional material, coupons, accessories, food, alcoholic beverages, furniture, animals, travel, vacations, merchandise, equipment, loans, credit cards, news, weather and adult content, among other topics. The content portions type may include, but are not limited to promotional material, text, pictures, audio files, references to audio streams and videos, among other types. Another aspect of the present invention is that the prompt can also allow the user to choose the size of the font of the text displayed in the content portions, and/or the option to choose to have the text of an advertisement run as an audio file, which are options especially beneficial for the seeing impaired. The topics and type of the content portions the user chooses can be parsed as an index and can be stored in the user preferences database 24, or in another database.

Once the user preferences have been stored, the HTML code associated with the original content portions is blocked and/or removed from the page, and in its place the HTML code associated with the substitute content portions, i.e., content portions related to the topics and/or type stored in user preferences database 24, are inserted in place of the HTML code associated with the original content portions. Thus, the user receives content portions based upon the user's preferences.

In addition, a rules base 345 and a randomizer 350 can each be accessed by the swap component 305. Based at least in part upon rules in the rules base 345 and any randomization requirements imposed by the randomizer 350, the swap component can access pieces of advertising from the advertisement data store 355. These pieces of advertising can be used as substitute content portions by the swap component 305 to substitute original ads such as those that can be found in a webpage as previously described in conjunction with FIGS. 1 and 2. In this manner, preferences can be expressly selected by a user. Randomization is described in greater detail below.

As another aspect of the present invention, the user can be given the option of choosing to receive a certain percentage of “random” content portions that are more loosely based on user preferences or not based on user preferences at all. These “random” content portions can be delivered based on alternate targeting methods, e.g., optionally taking user preferences into account, contextual targeting, behavior targeting, etc. The difference between “random” and “normal” content portions is that the user has less expectation for that content to be exactly what the user asked for, in receiving a “random” content portion. However, this does not necessarily mean that the content portion has to be completely random or that it completely ignores the user preferences store in user preferences database 24.

A further aspect of the invention is that the index of user preferences, stored in user preferences database 24, can be dynamically updated. For example, the user expressly chooses to receive content portions relating to bicycles, and thus receives bicycle advertisements while searching online. Once the user purchases a bicycle online, the topic of bicycle is dynamically removed from the index stored in the user preferences database 24. Additionally, once the user purchases a bicycle online, various topics related to bicycles (e.g., helmets, cycling attire, etc.) are dynamically added to the index stored in the user preferences database 24.

In the case where access to a user's online behavior is not available, the user may be prompted to provide information regarding which topics the user wishes to have added and/or removed from the index stored in the user preferences database 24. For example, the prompting may occur via a user interface which includes including checkboxes correlated to individual topics. For example, a user may remove topics from the user preferences database by two methods: unchecking the topic, or by clicking on a button next to the topic which indicates that the user has purchased a particular item, and thus no longer wishes to receive advertising relating to that particular topic.

A user interface (UI) 365, which can be implemented as a text-based interface, a graphical user interface (GUI), among others, can support or provide various functions accessible to a human user. For example, the UI 365 can include a rendering module 370 that can present information, such as the content 360, to a human user on some type of visual display (not shown) such as a cathode ray tube (CRT) screen, or a liquid crystal diode (LCD) screen. Additionally or alternatively, some type of printer (not shown) such as a laser or ink-jet printer can be used to create a human-readable form of the content 360.

The UI 365 can also access an input/output (I/O) module 375 that can be used to communicate with other nodes on a network. The I/O module 375 can support a variety of communication protocols at a variety of levels in a communication stack (not shown), including such exemplary protocols as HTTP, GET and POST commands at the application level and transport control protocol (TCP) and IP protocols at lower levels. Other protocols can also be supported as needed or desired in a specific implementation.

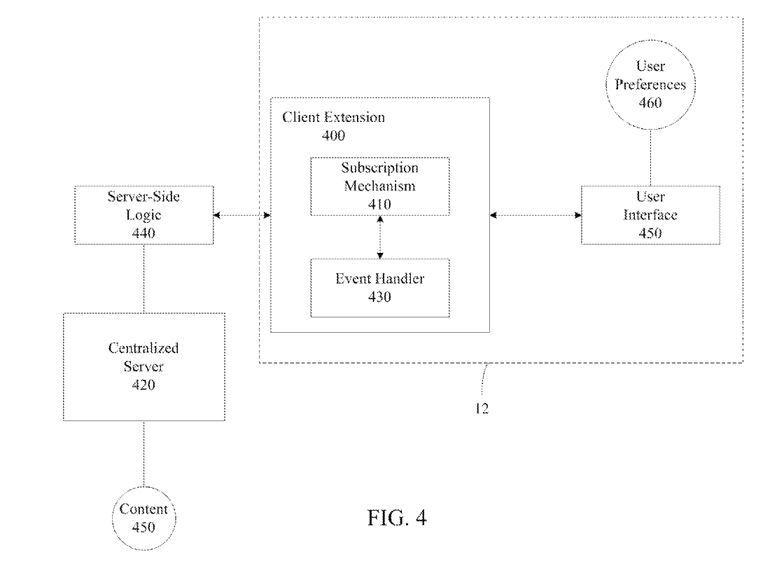

FIG. 4 is a block diagram showing a client extension 400 of client 12. The client extension 400 can include a subscription mechanism 410. The subscription mechanism 410 can gather, assemble, and use settings from a server, such as a centralized server 420. The centralized server 420 can store and distribute configuration files (not shown) that can include settings variables and values that can be used to adjust operation of the client extension 400. A variety of distribution mechanisms and policies can be applied to subscriptions and subscription settings.

The client extension 400 also can include an event handler 430. The event handler 430 can detect or intercept, as needed or appropriate, various system-level events that can be used to trigger or regulate operation of the client extension 400. Those of ordinary skill in this art area will readily recognize from reading this document that specific implementation details of the event handler 430 will differ depending upon a specific platform for which the client extension 400 is implemented. Such differences may even include support for architectures that use message-passing schemes instead of fired system events.

The centralized server 420 can execute code that implements server-side logic 440. The server-side logic can include rules, policies, and implementing code to cooperate with the subscription mechanism 410 of the client extension 400. Such cooperation can govern the provision of content 450 to the client extension 400.

A UI 450 can interact with the client extension 400. In this example, the UI 450 can be a web browser that includes features that permit extension of its functionality by using plug-ins. Additionally or alternatively, extendibility can be achieved by treating the web browser as a target platform and implementing the client extension 400 as a Java applet, a JavaScript script, an Active-X control, or another suitable architecture. The UI 450 can provide a mechanism by which a human user can access, set, and change a set of user preferences 460.

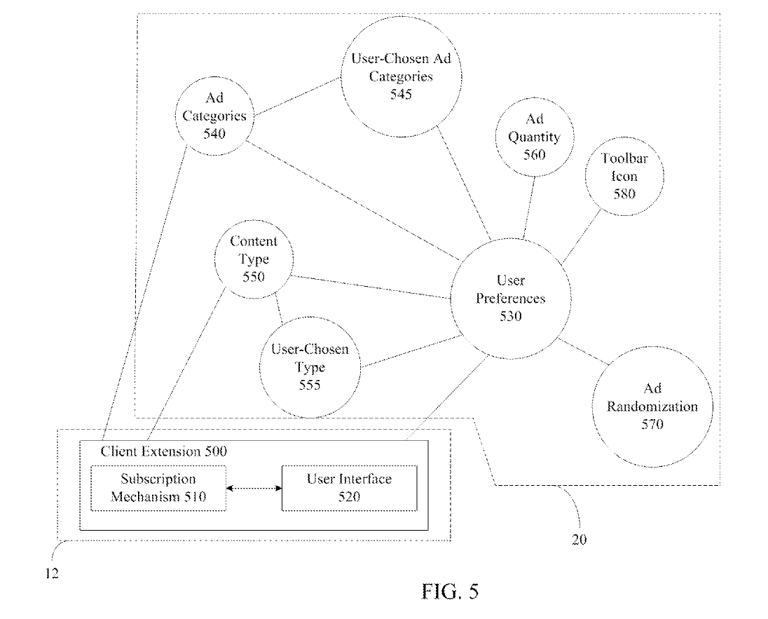

FIG. 5 is a block diagram of another client extension 500 of client 12. The client extension 500 can include both a subscription mechanism 510 and a UI 520. The UI 520 can access user preferences 530. The client extension 500, the subscription mechanism 510, the UI 520 and the user preferences 530 can be implemented in a similar fashion as the components described previously in conjunction with FIG. 4.

The subscription mechanism 510 of the client extension 500 can access ad categories 540 and content portions type 550. The user preferences 530 can include ad quantity 560, ad randomization 570, user-chosen ad categories 545, and user-chosen content portions type 555. The user-chosen ad categories 545 can be related to ad categories 540, and the user-chosen content portions type 555 can be related to content portions type 550. A toolbar icon 580 can be used to access the user preferences 530. The various data and content portions can be stored on server 20 or at other location(s).

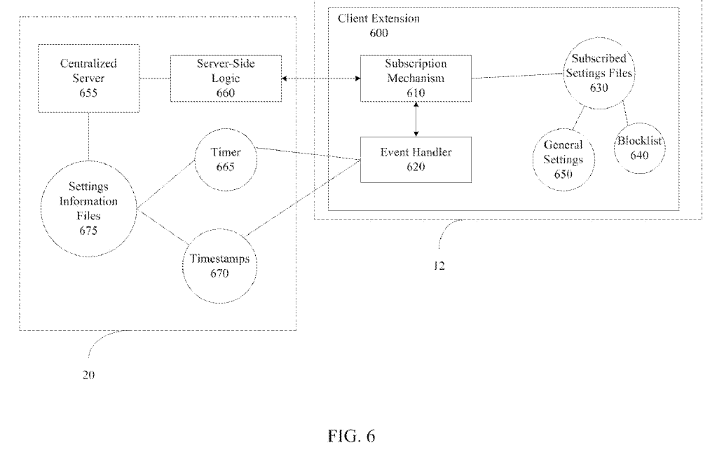

FIG. 6 is a system block diagram of another client extension 600 of client 12. The client extension 600 can include a subscription mechanism 610, and an event handler 620. The client extension 600, the subscription mechanism 610, and the event handler 620 can be implemented as previously described in conjunction with other figures.

The subscription mechanism 610 can access subscribed settings files 630. The subscribed settings files 630 can include a blocklist 640, listing content to blocked, and general settings 650. Information in these files can be used to regulate and control the client extension 600.

The client extension 600 can interact with a centralized server 655 that can execute code that implements server-side logic 660. The event handler 620 of the client extension 600 can access a timer 665 and timestamps 670 that can be associated or used with settings information files 675. Use of the timer 665 and the timestamps 670 can permit acquisition of current versions of the settings information files 675 and permit scheduled replacement of such files. The various data and content portions can be stored on server 20 or at other location(s).

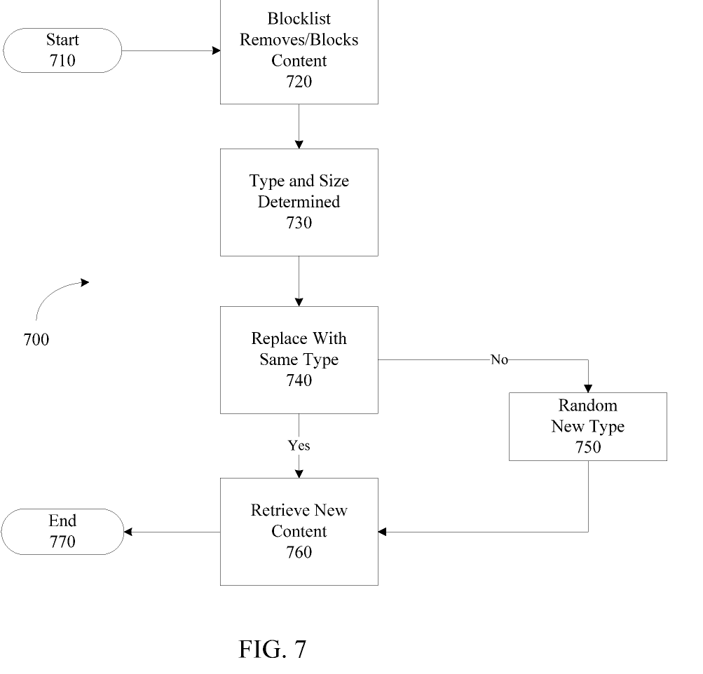

FIG. 7 is a flow diagram illustrating steps in a method 700 of operation of a client extension, such as the client extensions that have been previously described in conjunction with other figures. Execution of the method 700 begins at START block 710 and continues to process block 720, where a blocklist is accessed and content portions described by the blocklist is removed or blocked from, e.g., a webpage, by the client extension. At process block 730 content portions type and size are determined. A determination whether to replace blocked content portions with content portions of the same type is made at decision block 740. If this determination is negative, processing continues at process block 750 where content portions with a randomly-selected new content portions type is chosen.

Processing then continues at process block 760 where new content portions meeting selection criteria are retrieved. Processing also continues at process block 760 if the determination made at decision block 740 was affirmative. Execution of the method 700 terminates at END block 770.

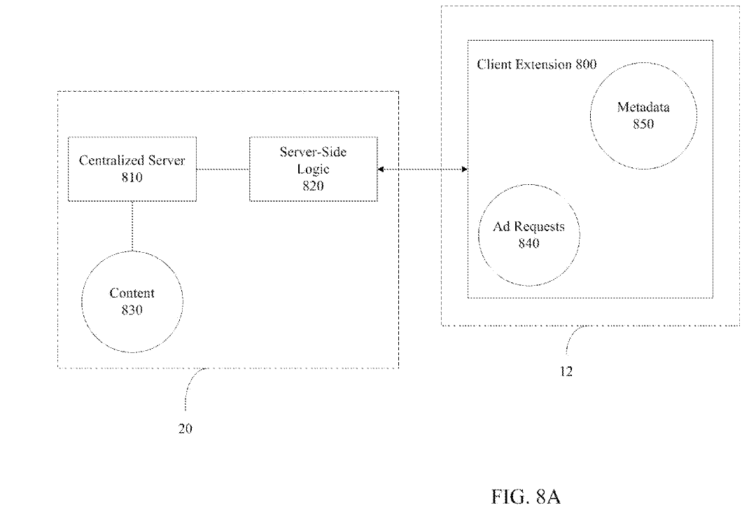

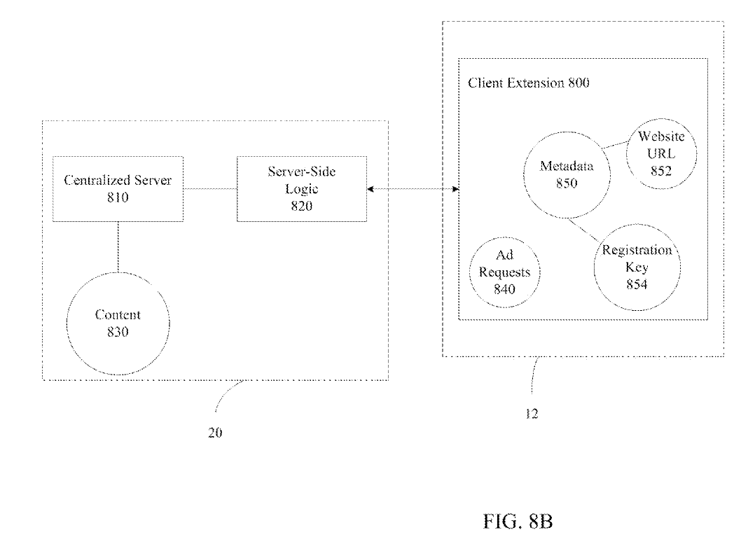

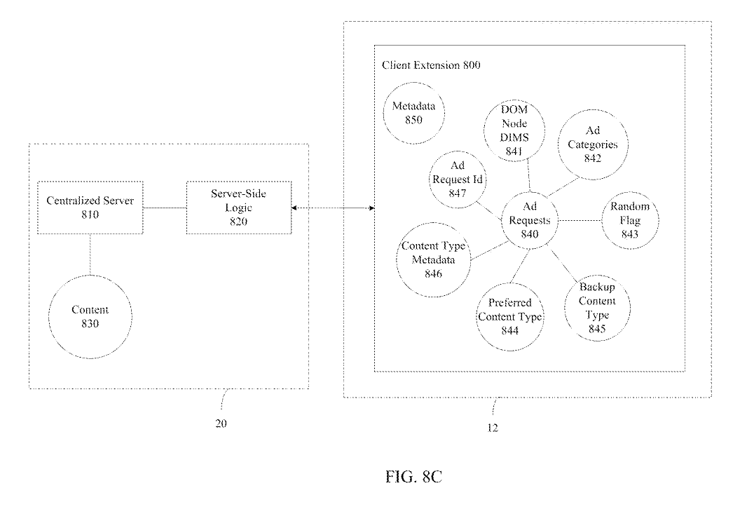

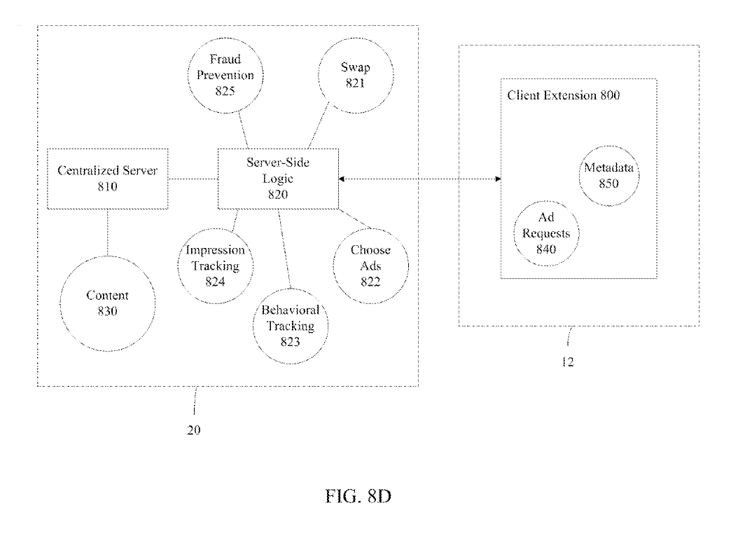

FIGS. 8A through 8D are system block diagrams depicting various portions of another client extension 800 of client 12. As shown in FIG. 8A, the client extension 800, a centralized server 810, and server-side logic 820 can be implemented as previously described in conjunction with other figures to access and use content portions 830. The client extension 800 can store information about ad requests 840 and metadata 850 about both requested ads and requests themselves. The various data and content portions can be stored on server 20 or at other location(s). As illustrated in FIG. 8B, the metadata 850 can include a uniform resource locator (URL) 852 for a requested ad hosted on a website as well as a registration key 854. The URL 852 provides location information so that a copy of an ad located at the specified URL can be retrieved. The registration key can serve as an identifier of a specific copy of the client extension 800. Used as an identifier, the registration key 854 can be used to assist in generating tracking information for a user and behavioral metrics. The various data and content portions can be stored on server 20 or at other location(s).

FIG. 8C illustrates further details of information that can be associated with the ad requests 840. DOM node dimensions 841 can be used to determine physical size of an ad as it would be displayed to a human user. Categories of ads 842 can be used to classify ad content portions. A random flag 843 can be used to determine whether the content portions should be considered for randomization by the server, as described below, taking the user settings for randomization 570 into account. Additionally or alternatively, the random flag can be associated with an ad to indicate whether a particular ad was one that was randomly chosen. The various data and content portions can be stored on server 20 or at other location(s).

When associating the random flag with an ad, implementation details will vary by file type. For example, if an ad is an MP3 file, the random flag may be implemented as a value stored in an ID field. Those of ordinary skill in this art area will readily recognize from reading this document that other implementations are possible and may be necessary, desired, or both depending upon various implementation-specific details.

Both a preferred content portions type 844 and a backup content type 845 can be used to determine types of content portions that can be requested as a primary request and then as a secondary request if content portions of the preferred type is not available. Content portions type metadata 846 can also be used. Lastly, an ad request ID 847 can be used to uniquely identify each request made by the client extension.

FIG. 8D depicts various details of the server-side logic 820. Code to implement the server-side logic 820 can include a variety of supported or ancillary functions. For example, a swap function 821 can determine whether to replace an original content portion with substitute content portions. Along with a swap determination, choosing of ads 822 can be implemented. Behavioral tracking features 823 can be included as well as impression tracking 824. Fraud prevention features 825 to identify automated requests as opposed to human-generated requests can be included as well.

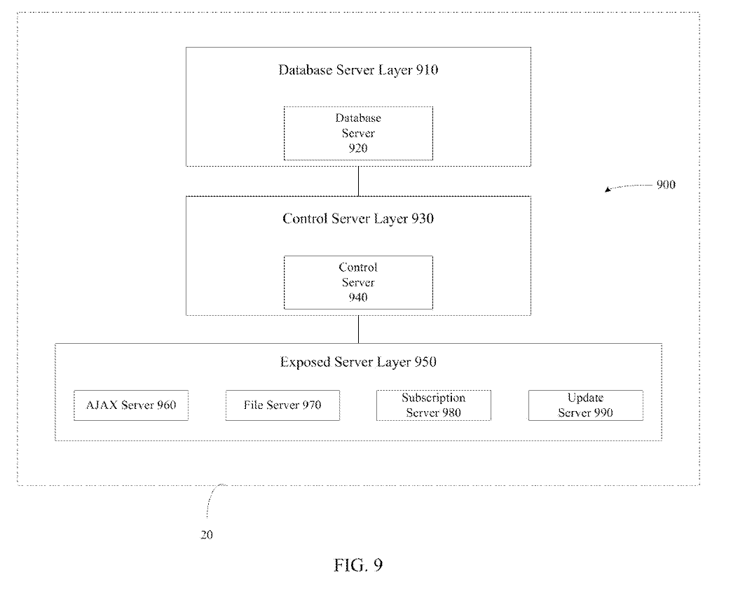

FIG. 9 is a system block diagram of server-side components 900 in a layered architecture, which describes server 20 in more detail. At a topmost layer, a database server layer 910 includes a database server 920. The database server layer can communicate with a middle control server layer 930. The control server layer 930 can include a control server 940. A bottom exposed server layer 950 can include a group of servers that can be exposed to a public network. Among these exposed servers are an AJAX server 960, a file server 970, a subscription server 980, and an update server 990.

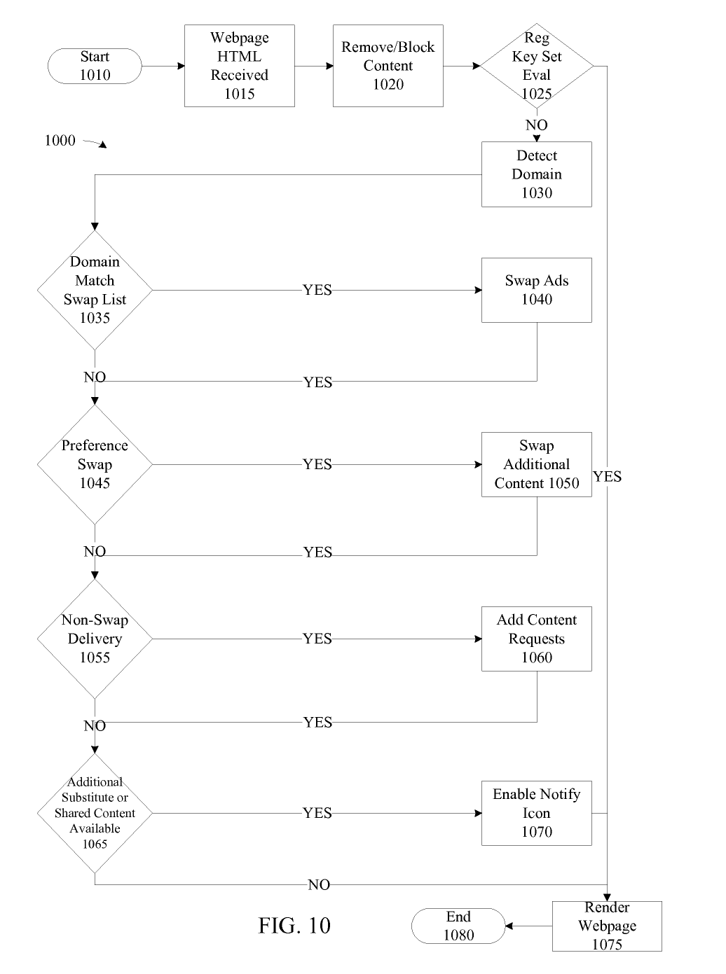

FIG. 10 is a flow diagram depicting steps in a method 1000 that can be used with components that have been described in conjunction with other figures. Processing of the method 1000 begins at START block 1010 and continues to process block 1015 where a client device 12 receives HTML code, such as the code associated with a web page and content portions. At process block 1020 content portions identified by the received HTML code is removed or blocked, at either the client device 12, if the application browser is removing or blocking the content portions, or at the swap server 20, if the content portions are removed or blocked at a proxy. At decision block 1025 a determination is made whether the registration key has been flagged for abuse, e.g., improperly monitoring a user's online activity. If this decision is negative, processing continues to process block 1030.

At process block 1030, a domain is detected. Processing continues at decision block 1035 where a decision is made whether the detected domain matches a domain included in a swap list. If that decision is YES, then processing continues to process block 1040 where ads are swapped. Processing then continues to decision block 1045. If the decision made at decision block 1035 is NO, processing continues to decision block 1045.

At decision block 1045, a determination is made whether preferred content portions is to be swapped, as described above with reference to other figures. If that determination is YES, processing continues to process block 1050. At process block 1050 additional content portions (e.g., advertisements listed in the user preferences database 24) is swapped, the HTML code of the additional content portions is swapped or inserted in place of the HTML code of the original content portions. Processing then continues to decision block 1055. If the determination made at decision block 1045 is NO, processing continues to process block 1055.

At decision block 1055, a decision is made whether nonswapped content portions has been delivered. If YES, processing continues to process block 1060. At process block 1060 additional content portions requests are created. Processing then continues to decision block 1065. If the determination made at decision block 1055 is NO, processing continues to decision block 1065.

At decision block 1065, a determination is made whether additional substitute or shared content portions is available. If that determination is YES, processing continues to process block 1070 where a notification icon is enabled. Processing then continues to process block 1075. Processing at process block 1075 can also occur if the determination made at decision block 1025 is YES or if the decision made at decision block 1065 is NO. At process block 1075 a webpage based at least in part on the original HTML code and modifications made to the HTML code of the removed and/or blocked content portions (i.e., the HTML code of the substitute content portions) is rendered at the client device 12, e.g., as a webpage with ads. The insertion of HTML code associated with the substitute content portions transforms the webpage. Processing then terminates at END block 1080.

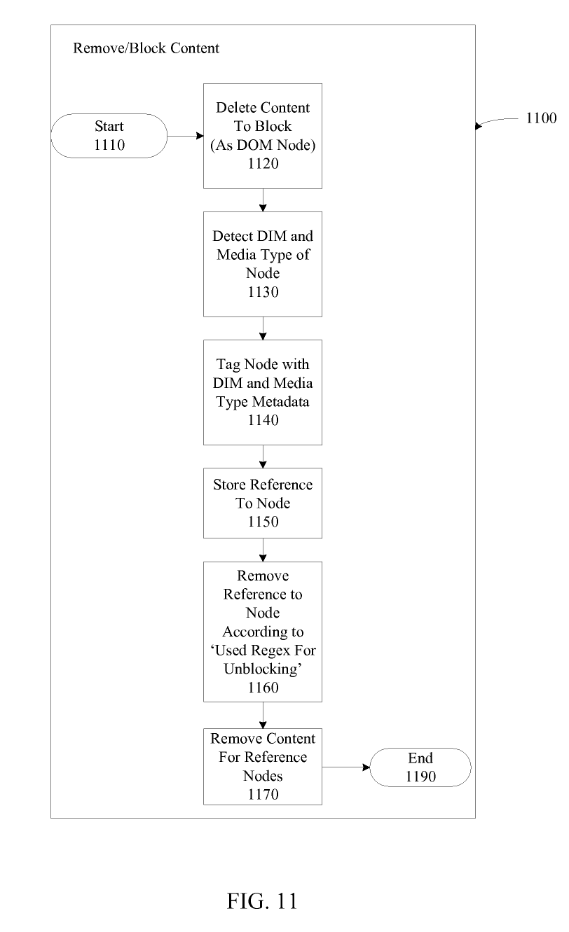

FIG. 11 is a flow diagram depicting steps in a method 1100 to remove or block content portions. Processing of the method 1100 begins at START block 1110 and continues to process block 1120. At process block 1120 content portions to be blocked (e.g., an webpage advertisement), in the form of a DOM node, is designated as being subject to deletion, either at the client device 12 or the server 20. Processing continues to process block 1130 where dimensions and media type associated with the DOM node to be deleted are detected or calculated.

The node is tagged with dimension and media type metadata at process block 1140. A reference to the node is stored at process block 1150. At process block 1160 a reference to the DOM node to be deleted is removed using a “used regex for unblocking” procedure. Processing continues at process block 1170 where content portions for referenced nodes is removed. Execution of the method 1100 terminates at END block 1180.

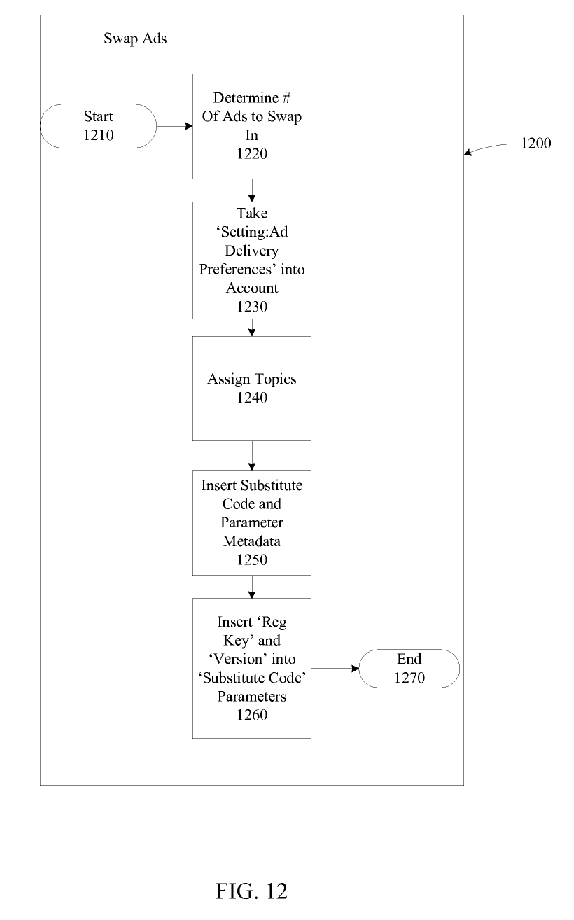

FIG. 12 is a flow diagram depicting steps in a method 1200 to swap ads. Processing of the method 1200 begins at START block 1210 and continues to process block 1220. At process block 1220 a number of ads to swap into a webpage is calculated. Processing continues to process block 1230 where preferences stored in ad delivery settings are taken into account.

Topics are assigned at process block 1240. Insertion of substitute code and parameter metadata occurs at process block 1250. At process block 1260 components previously described above insert “reg key” and “version” into substitute code parameters. Execution of the method 1200 terminates at END block 1270.

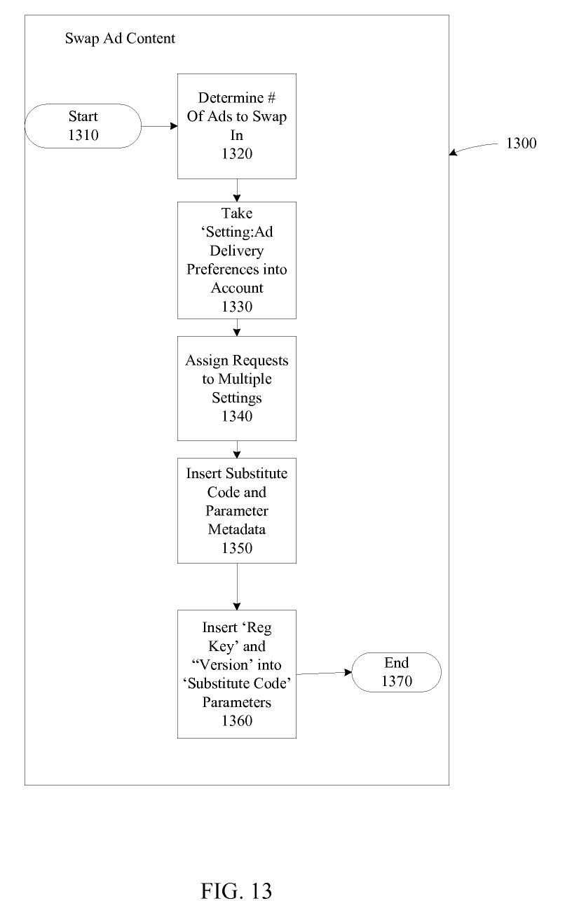

FIG. 13 is a flow diagram depicting steps in a method 1300 to swap content portions. Processing of the method 1300 begins at START block 1310 and continues to process block 1320. At process block 1320 a number of pieces of content portions to swap into a web page is calculated. Processing continues to process block 1330 where preferences stored in ad delivery settings are taken into account.

At process block 1340 components earlier described in conjunction with other figures assign requests to multiple settings. Insertion of substitute code and parameter metadata occurs at process block 1350. At process block 1360 components previously described above insert “reg key” and “version” into substitute code parameters. Execution of the method 1300 terminates at END block 1370.

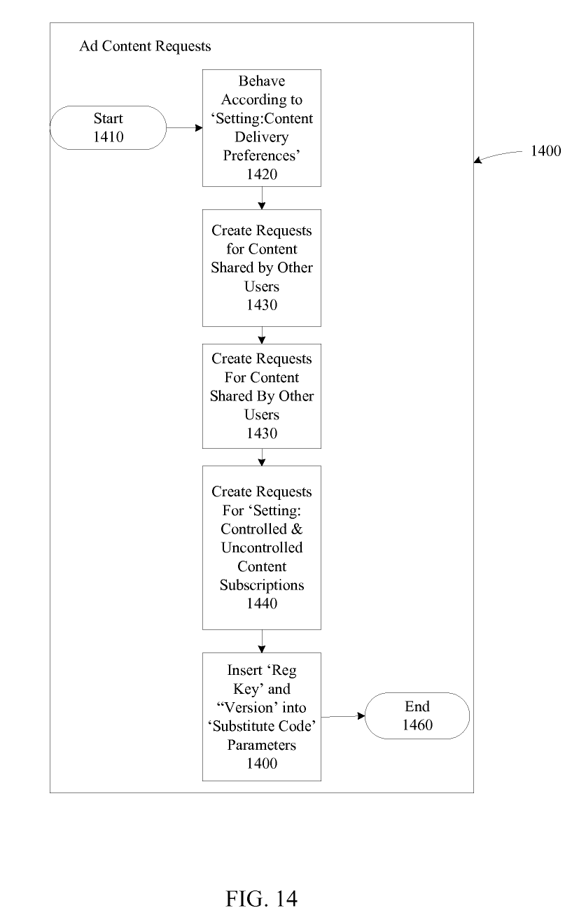

FIG. 14 is a flow diagram depicting steps in a method 1400 to handle additional content portions requests. Processing of the method 1400 begins at START block 1410 and continues to process block 1420. At process block 1420 processing components are directed to behave in accordance with previously selected content portions delivery preferences. Processing continues to process block 1430 where requests for content portions shared by other users are created.

At process block 1440 requests for controlled and uncontrolled content portions subscriptions are created in accordance with previously selected preference settings. At process block 1450 components previously described above insert “reg key” and “version” into substitute code parameters. Execution of the method 1400 terminates at END block 1460.

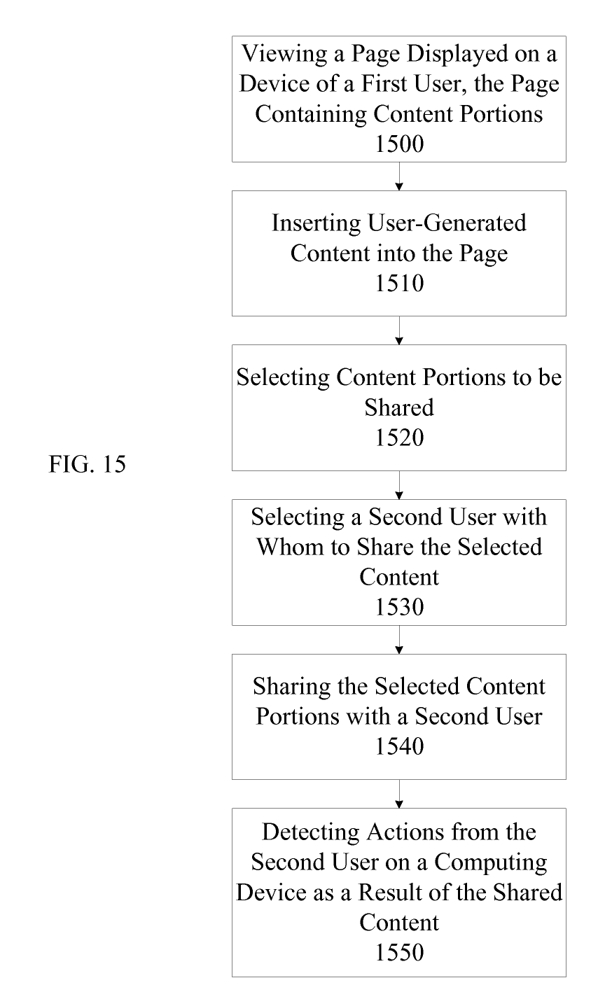

FIG. 15 illustrates a flowchart for sharing content portions from a page displayed on a device of a first user with a second user. Each step in FIG. 15 will be described in greater detail below. In step 1500, a page which is displayed on a device of a first user is viewed. The page contains content portions, which include, for example, advertisements, pictures, text or media. User-generated content portions can be inserted into the page, in step 1510. Following which, in step 1520, the content portions to be shared are selected. In step 1530, the second user with whom the selected content is to be shared is selected. Next, step 1540 shares the selected content portions with a second user. Finally, actions from the second user, as a result of the shared content portions, are detected on a computing device, in step 1550.

Additionally, the selected content portions, in step 1520, can be user-generated content portions. The second user can be selected from a list, which can be a predetermined list, in step 1530. The second user can receive the content portions via at least one of email, a text message, a picture message, an instant message and an automated voice call. Detecting step 1550 can also include tracking and measure pre-sales advertising efforts. Further, detecting step 1550 can include detecting generation of revenue and issuing a commission to the first user in response to the generation of revenue. Furthermore, detecting step 1550 may include an actual purchase related to the advertisement by the second user.

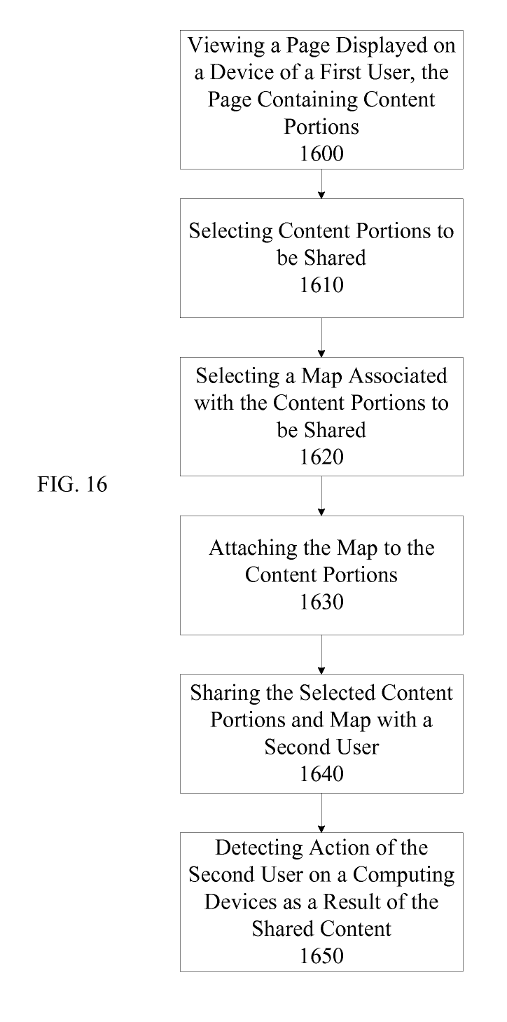

FIG. 16 illustrates a flowchart for sharing content portions from a page, with an associated map attached thereto, displayed on a device of a first user with a second user. Each step in FIG. 16 will be described in greater detail below. In step 1600, a page which is displayed on a device of a first user is viewed, the page containing content portions, which include, for example, advertisements, pictures, text or media. Next, in step 1610, the content portions to be shared are selected. In step 1620, a map associated with the selected content portions is selected. The map is attached to the content portions in step 1630. Following which, the selected content portions and the associated map are shared with a second user, in step 1640. Finally, actions of the second user as a result of the shared content portions are detected on a computing device, in step 1650.

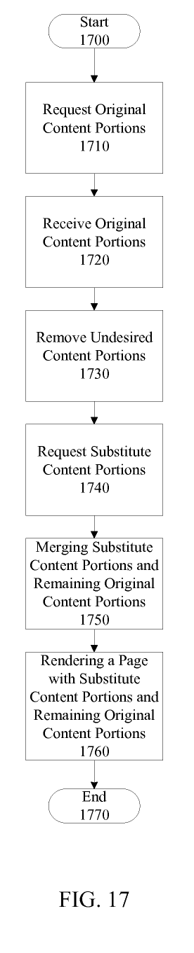

FIG. 17 depicts a flowchart for removing undesired original content portions and its place inserting substitute content portions. Each step in FIG. 17 will be described in greater detail below. The process begins at START block 1700. In step, 1710 original content portions are requested. For example, the content portions can be advertisements displayed on a webpage. Next, in step 1720 the original content portions are received, for example at the browser of a client device. Following which, in step 1730, substitute content portions are requested. For instance, the substitute content portions can be advertisements that fit the requirements specified in the user preference database 24. The substituted content portions are merged with the remaining original content portions in step 1750. Finally, a page with the substitute content portions and the remaining content portions is rendered in step 1760, i.e., a transformed webpage is rendered with the substitute content portions and the remaining content portions. Execution of the process terminates at END block 1770.

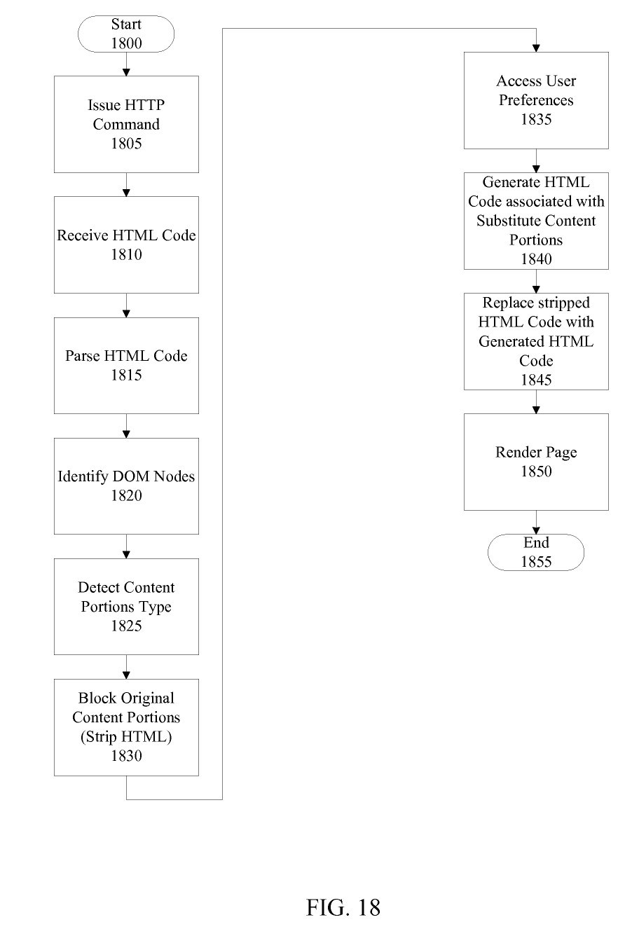

FIG. 18 exemplifies a flowchart for replacing original content portions with generated substitute content portions on a page. Each step in FIG. 18 will be described in greater detail below. The operation of this particular embodiment begins at START block 1800. In step 1805, a hypertext transfer protocol (HTTP) command is issued to a web server. Next, a file that includes a hypertext markup language (HTML) code is received in step 1810. The HTML code is parsed in step 1815. Document object model (DOM) nodes are identified in step 1820. Following which, detecting content portions type occurs in step 1825. Following which, the original content portions are blocked by stripping the HTML code associated with the detected content portions, in step 1830. Stored user preferences are accessed in step 1835. Next, in step, 1840, HTML code associated with substitute content portions, based on user preferences is generated. The stripped HTML code of the blocked content portions is next replaced with the generated HTML code associated with the substitute content portions, in step 1845. Finally, in step 1850, a transformed page is rendered based at least in part on the generated HTML code. Execution of the process terminates at END block 1855.

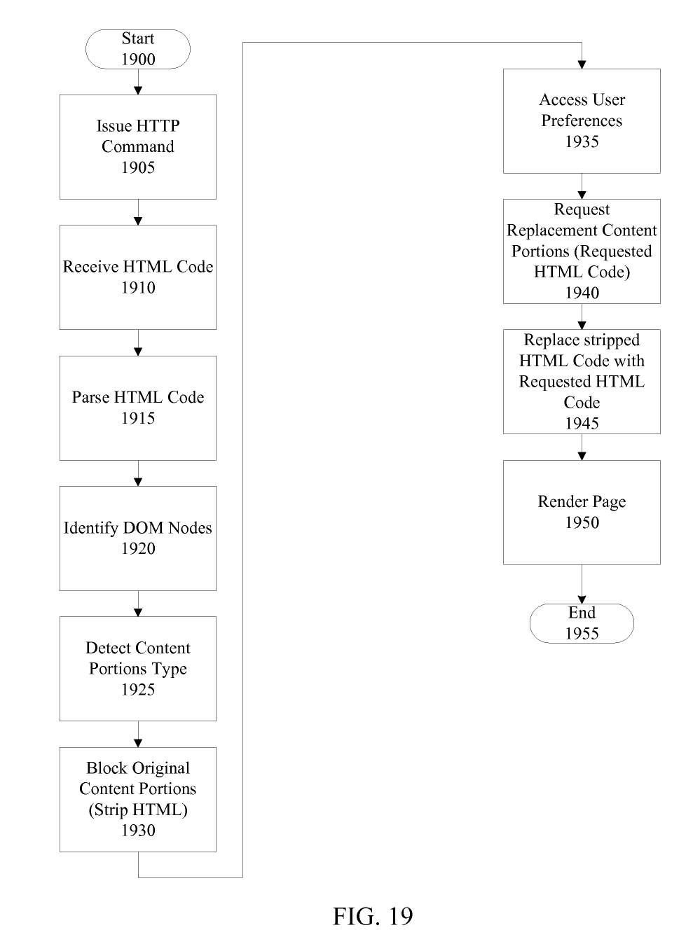

FIG. 19 illustrates a different flowchart for replacing original content portions with replacement content portions on a page. Each step in FIG. 19 will be described in greater detail below. The operation of this particular embodiment begins at START block 1900. In step 1905, a hypertext transfer protocol (HTTP) command is issued to a web server. Next, a file that includes a hypertext markup language (HTML) code is received in step 1910. The HTML code is parsed in step 1915. Document object model (DOM) nodes are identified in step 1920. Following which, detecting content portions type occurs in step 1925. Following which, the original content portions are blocked by stripping the HTML code associated with the detected content portions, in step 1930. Stored user preferences are accessed in step 1935. Next, in step, 1940, HTML code associated with substitute content portions, based on user preferences is requested. The stripped HTML code of the blocked content portions is next replaced with the requested HTML code associated with the substitute content portions, in step 1945. Finally, in step 1950, a transformed page is rendered based at least in part on the substitute content portions. Execution of the process terminates at END block 1955.

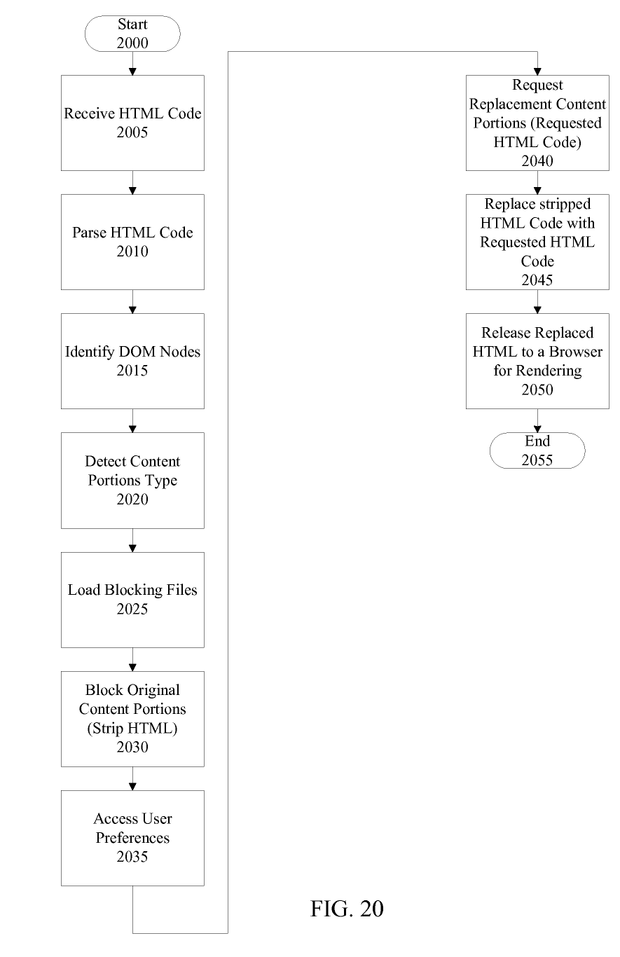

FIG. 20 illustrates a flowchart for replacing original content portions with replacement content portions on a page. Each step in FIG. 20 will be described in greater detail below. The operation of this particular embodiment begins at START block 2000. In step 2005, a data stream that includes a hypertext markup language (HTML) code is received. Next, the HTML code is parsed, in step 2010. Document object model (DOM) nodes are identified in step 2015. Following which, detecting content portions type occurs in step 2020. After that, in step 2025, blocking files are loading. Following which, the original content portions are blocked by stripping the HTML code associated with the detected content portions in step 2030. Stored user preferences are accessed in step 2035. Next, in step, 2040, HTML code associated with substitute content portions, based on user preferences is requested. The stripped HTML code of the blocked content portions is next replaced with the requested HTML code associated with the substitute content portions in step 2045. Finally, in step 2050, the replaced HTML associated with the substitute content portions are released to a browser to be rendered, e.g., in a transformed page. Execution of the process terminates at END block 2055.

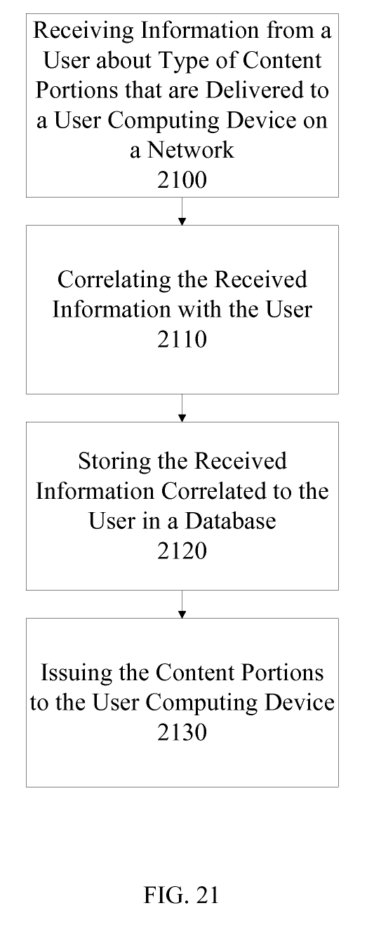

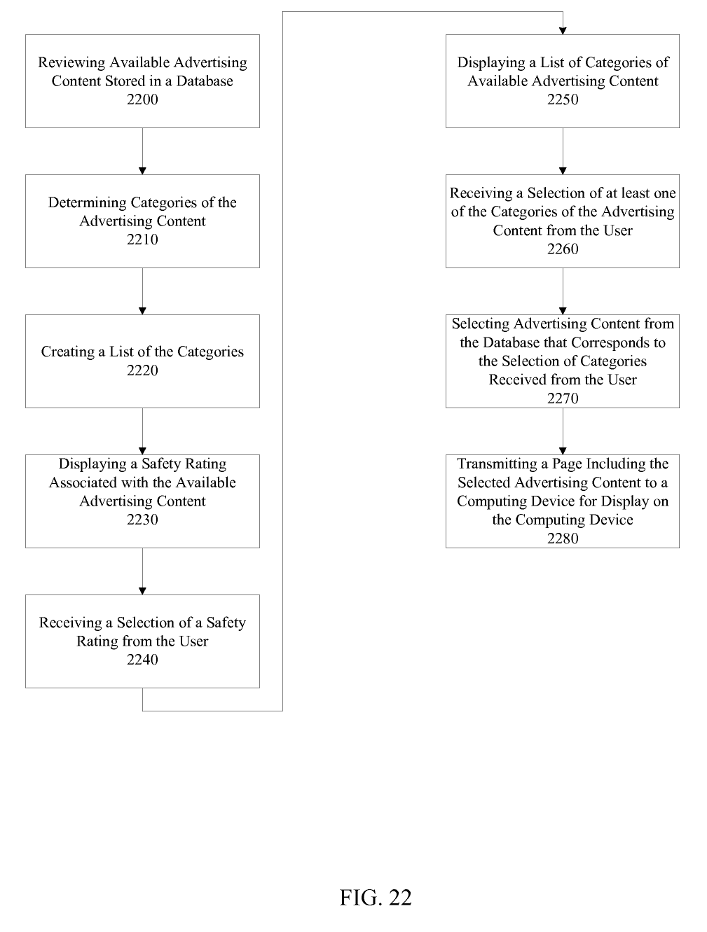

FIG. 21 illustrates a flow diagram for passive searching. A detailed description of each step in FIG. 21 now follows. In step 2100 information from a user about the type of content portions that are to be delivered to a user computing device on a network is received. Next, the received information is correlated with the user in step 2110. The received information correlated to the user is stored in a database in step 2120, e.g., in user preference database 24. Then, the content portions are issued to the user computing device in step 2130.

Additionally, in step 2130 the content portions can be issued to the user when the user is within range of a transmitting device, wherein the transmitting device can include a store or vender. Regarding step 2100, the information can include a list of products and product information, wherein the product information includes at least one of availability, price and sales. Furthermore, the information can be related to specific products, and changes dynamically based on user needs. The user computing device can be a client computer.

FIG. 22 depicts a flow chart for targeting content. A detailed description of each step in FIG. 22 now follows. In step 2200 the available advertising content stored in a database is reviewed. Next, in step 2210, the categories of the advertising content are determined. After which, a list of the categories of advertising content is created, in step 2220. Then, a safety rating associated with the available advertising content is displayed, in step 2230. In step 2240, a selection of a safety rating from the user is received. Then, a list of the categories of the available advertising content is displayed in step 2250. Following which, a selection of at least one of the categories of the advertising content from the user is received in step 2260. Advertising content that corresponds to the selection of categories received from the user is selected from the database in step 2270. Finally, in step 2280, a page including the selected advertising content is transmitted to a computing device for display on the computing device.

Additionally, in step 2250 the categories can be organized in a schema, and can include subcategories. Further, the list of categories can include a checkbox for each category in the list for selection by the user. Furthermore, the categories can include topics of the advertising content, wherein the topics may include specific products or services. The products or services can be related to at least one of sports, automobiles, clothing, accessories, promotional material, food, alcoholic beverages, furniture, animals, travel, vacations, merchandise, equipment, loans, credit cards, news, weather and adult content, among other things. The categories may also include the type of advertising content that is displayed, e.g., text, pictures, audio files, references to audio streams and video to name a few. The present invention also contemplates that text ad blocks, comprising multiple text ads, may fit into to space of the original advertising content. For instance, if an image is removed from a data stream, based on the size of the image, the present invention will calculate the number of text ads that can fit into the image's dimensions. It will also determine how to best format the text ads.

The safety ratings of the present invention are used to control what levels of objectionable content a user may receive. Safety ratings can take age into account, so that the level of objectionable content a user receives is correlated with the user's age.

In addition, using the above features of FIG. 22 gives a user direct control over the topics of advertising that the user will receive. The primary mechanism for user control is a nested list of topics (i.e., schema) that directly relates to the topics and products that are used to categorize available advertisements. This includes a topic suggestion engine that can equate data with a suggested list of topic choices. For instance, the use of this engine can extract a user's stated interest from an online profile, such as Facebook, and equate that text of the profile to a set of advertising topics.

Furthermore, this method of passive searching can be used for self-targeting, independent of content swapping. Content swapping is merely one of many possible methods of delivery. Passive search could be developed into a Web 2.0 mechanism, in which a user visits a site, the site determines the identity of the user, the site requests advertising content from an ad server and then passes the user's identity along with the request. Next, the ad server will return advertising content that is appropriate for that user back to the site, and the site displays the ads to the user.

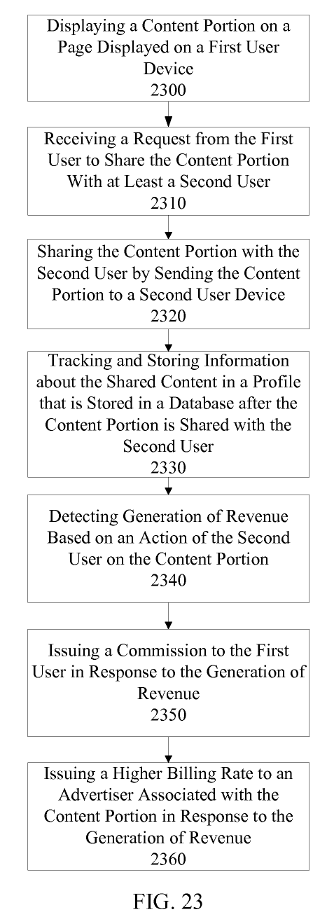

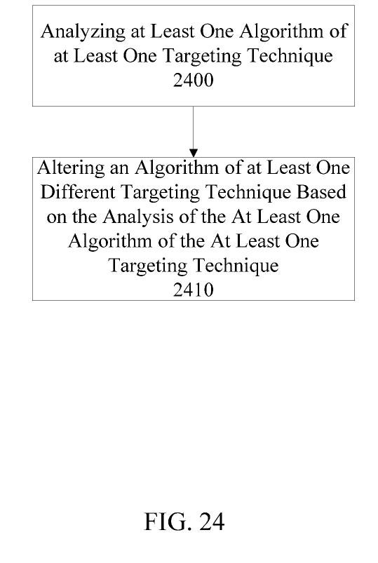

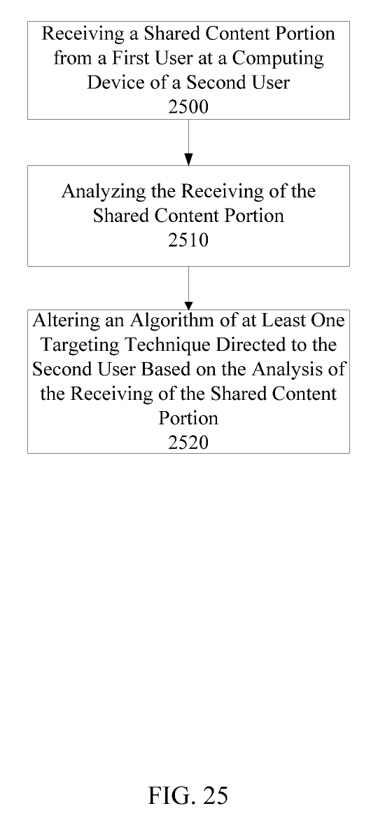

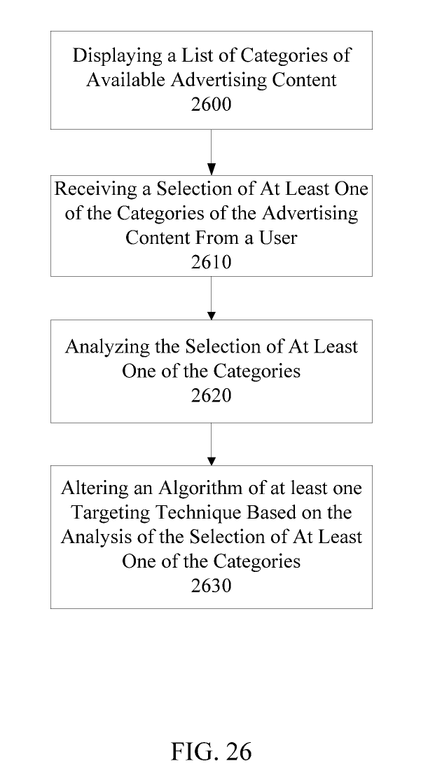

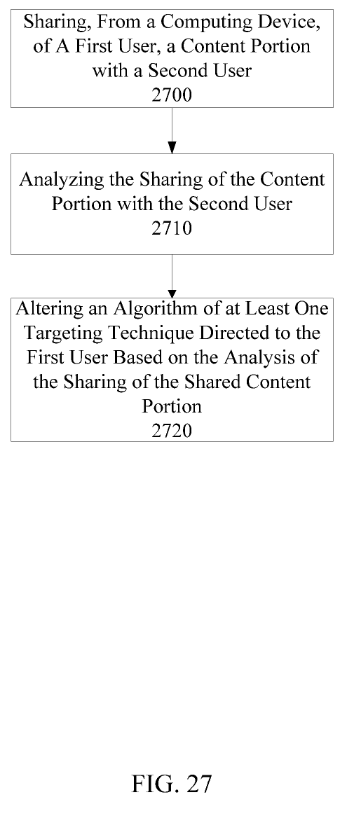

FIG. 23 illustrates a flow chart for tracking peer-to-peer sharing of content portions displayed on a user computing device that eventually generates revenue. A detailed description of each step in FIG. 23 now follows. In step 2300 content portions are displayed on a page displayed on a first user device. Next, a request from the first user to share the content portion with at least a second user is received, in step 2310. After which, in step 2320, the content portion is shared with the second user by sending the content portion to a second user device. In step 2330, information about the shared content portion is tracked and stored in a profile in a database, after the content portion is shared with the second user. Then, in step 2340, generation of revenue based on an action of the second user on the content portion is detected. Issuing a higher billing rate to an advertiser associated with the content portion in response to the generation of revenue in step 2350. Issuing a new billing rate associated with an advertiser is accomplished in step 2360.

Furthermore, the method can include receiving a request from the first user to attach a map to the content portion, and attaching a map to the content portion, wherein the map is related to the content portion. Also, the method may include receiving information related to the location the second user and the content portion, and issuing a map to the second user.

Additionally, the selected content portions, in step 2310, the second user can be selected from a list, which can be a predetermined list. The second user can receive the content portions via at least one of email, a text message, a picture message, an instant message, a host website and an automated voice call. The second user can be selected from a list, and the list can be a predetermined list. Further, the second user may be the first user on a different user device. Additionally, the content portions can be at least one of an advertisement, a coupon, a picture, a text or media. Peer-to-peer sharing may include sharing a content portion from a first user device of a first user to a second user device of the first user. Additionally, the content portions of this example may be coupons that are sent to a user's mobile device. The user may then use the mobile device in a store to receive a discount when purchasing a product, or if the user purchases a product online, the user may electronically use the coupon.

The invention can be implemented over any type of communications channel, such as the Internet, a local area network (LAN), a wide area network (WAN), direct computer connections, or the like, using any type of communication hardware and protocols. Any type of hardware or combination of hardware can be used for various clients and servers. Accordingly, the term “computer” as used herein, refers to any type of computing device or data terminal, such as a personal computer, a portable computer, a dumb terminal, a thin client, a hand held device or any combination of such devices. The various clients and servers can be a single computer at a single location or multiple computers at a single or multiple locations. For example, a server may be comprised of a plurality of redundant computers disposed in co-location facilities at various locations to facilitate scalability. Any appropriate server or client software can be used and any communication protocols can be used. Communication can be accomplished over electric cable, fiber optic cable, any other cable, or in a wireless manner using radio frequency, infrared, or other technologies. Any interface can be used for selecting products for purchase. The various information can be stored in any format and thus the term “database” as used herein refers to any collection of information such as a database file, a lookup table, or the like.

The invention has been described through a preferred embodiment. However, various modifications can be made without departing from the scope of the invention as defined by the appended claims and legal equivalents.

1. A method for targeting content that is arranged on a page that is displayable by a computing device, comprising the steps of:
displaying a list of categories of available advertising content, wherein the available advertising content is stored in a database;
receiving a selection of at least one of the categories of the advertising content from a user;
selecting advertising content from the database that corresponds to the selection of categories received from the user; and
transmitting a page including the selected advertising content to the computing device for display on the computing device.

2. The method according to claim 1, further comprising:
reviewing the advertising content stored in the database;
determining categories of the advertising content; and
creating a list of the categories.

3. The method according to claim 1, wherein the categories are organized in a schema.

4. The method according to claim 1, wherein the list of categories include a checkbox for each category in the list.

5. The method according to claim 2, wherein the list of categories includes subcategories.

6. The method according to claim 1, wherein the page includes a webpage.

7. The method according to claim 1, wherein the categories include topics of the advertising content.

8. The method according to claim 1, wherein the categories include the type of the advertising content.

9. The method according to claim 7, wherein the topics of the advertising content are include at least one of sports, automobiles, clothing, promotional material, coupons, accessories, food, alcoholic beverages, furniture, animals, travel, vacations, merchandise, equipment, loans, credit cards, news, weather and adult content.

10. The method according to claim 8, wherein the type of advertising content includes promotional material, text, pictures, audio files, references to audio streams, and video.

11. The method according to claim 1, further comprising:
displaying a safety rating associated with the available advertising content; and
receiving a selection of a safety rating from the user.

12. The method according to claim 11, wherein the safety rating displayed is a slide scale.

13. The method according to claim 11, wherein age is taken into account by the safety rating.

14. A method of peer-to-peer sharing of content portions of a page displayed on a user computing device, wherein the peer-to-peer sharing occurs on a social network platform, comprising the steps of:
displaying at least one content portion on a page displayed on a first user device;
receiving a request from the first user to share at least one content portion with at least one second user;
sharing the content portion with the second user by sending the content portion to a second user device;
tracking and storing information about the shared content in a profile that is stored in a database after the content portion is shared with the second user, wherein the profile is associated with the first user; and
detecting generation of revenue based on an action of the second user on the content portion.

15. The method according to claim 14, wherein the second user is selected from a list.

16. The method according to claim 15, wherein the list is a predetermined list.

17. The method according to claim 14, wherein the content portions are at least one of an advertisement, a coupon, a picture, a text or media.

18. The method according to claim 14, wherein the second user's user device receives the content portions through at least one of email, a text message, a picture message, an instant message, a host website and an automated voice call.

19. The method according to claim 14, further comprising:
receiving a request from the first user to attach a map to the content portion; and
attaching a map to the content portion,
wherein the map is related to the content portion.

20. The method according to claim 14, wherein the second user is able to interact with the shared content portion to retrieve a map related to the content portion.

21. The method according to claim 14, wherein the second user is able to interact with the shared content portion to retrieve consumer information related to the shared content portion.

22. The method according to claim 14, further comprising:
issuing a higher billing rate to an advertiser associated with the content portion in response to the generation of revenue.

23. The method according to claim 19, further comprising:
receiving information related to the location the second user and the content portion; and
issuing a map to the second user based on the location of the second user

24. The method according to claim 14, wherein the second user is the first user, and the second user device is a mobile device of the first user.

25. The method according to claim 24, wherein the content portion is a coupon.

26. The method according to claim 14, wherein the second user has a predefined relationship on the social network with the first user.

27. A system for targeting content that is arranged on a page that is displayable by a computing device, comprising:
means for displaying a list of categories of available advertising content, wherein the available advertising content is stored in a database;
means for receiving a selection of at least one of the categories of the advertising content from a user;
means for selecting advertising content from the database that corresponds to the selection of categories received from the user; and
means for transmitting a page including the selected advertising content to a computing device for display on the computing device.

28. The system according to claim 27, further comprising:
means for reviewing the advertising content stored in the database;
means for determining categories of the advertising content; and
means for creating a list of the categories.

29. The system according to claim 27, wherein the categories are organized in a schema.

30. The system according to claim 27, wherein the list of categories include a checkbox for each category in the list.

31. The system according to claim 28, wherein the list of categories includes subcategories.

32. The system according to claim 27, wherein the page includes a webpage.

33. The system according to claim 27, wherein the categories include topics of the advertising content, wherein the topics include specific products or services.

34. The system according to claim 27, wherein the categories include the type of the advertising content.

35. The system according to claim 33, wherein the topics of the advertising content include at least one of ports, automobiles, clothing, promotional material, coupons, accessories, food, alcoholic beverages, furniture, animals, travel, vacations, merchandise, equipment, loans, credit cards, news, weather and adult content.

36. The system according to claim 34, wherein the type of advertising content includes promotional material, text, pictures, audio files, references to audio streams, and video.

37. The system according to claim 27, further comprising:
means for displaying a safety rating associated with the available advertising content; and
means for receiving a selection of a safety rating from the user.

38. The system according to claim 37, wherein the safety rating displayed is a slide scale.

39. The system according to claim 37, wherein age is taken into account by the safety rating.

40. A system for peer-to-peer sharing of content portions of a page displayed on a user computing device, wherein the peer-to-peer sharing occurs on a social network platform, comprising:
means for displaying at least one content portion on a page displayed on a first user device;
means for receiving a request from the first user to share at least one content portion with at least one second user;
means for sharing the content portion with the second user by sending the content portion to a second user device;
means for tracking and storing information about the shared content in a profile that is stored in a database after the content portion is shared with the second user, wherein the profile is associated with the first user; and
means for detecting generation of revenue based on an action of the second user on the content portion.

41. The system according to claim 40, wherein the second user is selected from a list.

42. The system according to claim 41, wherein the list is a predetermined list.

43. The system according to claim 40, wherein the content portions are at least one of an advertisement, a coupon, a picture, a text or media.

44. The system according to claim 40, wherein the second user's user device receives the content portions through at least one of email, a text message, a picture message, an instant message, a host website and an automated voice call.

45. The system according to claim 40, further comprising:
means for receiving a request from the first user to attach a map to the content portion; and
means for attaching a map to the content portion,
wherein the map is related to the content portion.

46. The system according to claim 40, wherein the second user is able to interact with the shared content portion to retrieve a map related to the content portion.

47. The system according to claim 40, wherein the second user is able to interact with the shared content portion to retrieve consumer information related to the shared content portion.

48. The system according to claim 40, further comprising:
means for issuing a higher billing rate to an advertiser associated with the content portion in response to the generation of revenue.

49. The system according to claim 45, further comprising:
means for receiving information related to the location the second user and the content portion; and
means for issuing a map to the second user based on the location of the second user.

50. The system according to claim 40, wherein the second user is the first user, and the second user device is a mobile device of the first user.

51. The system according to claim 50, wherein the content portion is a coupon.

52. The system according to claim 40, wherein the second user has a predefined relationship on the social network with the first user.

53. The method according to claim 14, further comprising:
issuing a commission to the first user in response to the generation of revenue.

54. The system according to claim 40, further comprising:
means for issuing a commission to the first user in response to the generation of revenue.

55. The method according to claim 7, wherein the topics include specific products or services.

56. The system according to claim 33, wherein the topics include specific products or services.

57. The method according to claim 1, further comprising:
tracking user activity on the computing device; and
updating the selection of at least one of the categories based on the user activity.

58. The method according to claim 57, further comprising:
suggesting an altered list of categories based on user activity.

59. The method according to claim 57, wherein the selection of at least one of the categories is updated to include at least a topic related to the user activity.

60. The method according to claim 57, wherein the selection of at least one of the categories is updated to remove at least a topic related to the user activity.

61. The method according to claim 57, wherein the user activity includes a purchase.

62. The method according to claim 1, wherein a percentage of the selected advertising content is selected to be random, and a percentage of the selected advertising content is not selected at random.

63. The method according to claim 1, further comprising:
selecting different advertising content from the database that corresponds to a different targeting technique; and
transmitting the page including the selected different advertising content to the computing device for display on the computing device.

64. The method according to claim 1, further comprising:
displaying a list of topics related to demographic information;
receiving a selection of at least one of the topics of demographic information from the user; and
updating the selection of at least one categories based on receiving the selection of the at least one of the topics of demographic information.

65. The method according to claim 57, further comprising:
inferring behavioral information from the user activity.

66. The method according to claim 65, wherein the behavioral information includes contextual information.

67. The method according to claim 65, the inferring step comprising:
identifying at least one of keyword metadata of a page that is visited by a user on the computing device, keywords located in the content loaded into the page visited by the user on the computing device, and the domain of the page visited by the user on the computing device.

68. The method according to claim 1, further comprising:
receiving a shared content portion from a second user;
tracking actions by the user on the shared content portion; and
updating the selection of the at least one of the categories stored in the database to reflect the actions by the user on the shared content portion.

69. The method according to claim 1, further comprising:
receiving a shared content portion from a second user; and
updating the selection of the at least one of the categories stored the database, to reflect information related to the shared content portion.

70. A method for improving at least one content targeting technique, wherein content is targeted to a user based on a targeting algorithm and the targeted content is arranged on a page that is displayable by a computing device, comprising the steps of:
displaying a list of categories of available advertising content, wherein the available advertising content is stored in a database;
receiving a selection of at least one of the categories of the advertising content from a user;
analyzing the selection of at least one of the categories; and
altering an algorithm at least one targeting technique based on the analysis of the selection of at least one of the categories.

71. A method for improving at least one content targeting technique, wherein content is targeted to a user based on a targeting algorithm and the targeted content is arranged on a page that is displayable by a computing device, comprising the steps of:
receiving a shared content portion from a first user at a computing device of a second user;
analyzing the receiving of the shared content portion; and
altering an algorithm of at least one targeting technique directed to the second user, based on the analysis of the receiving of the shared content portion.

72. A method for improving at least one content targeting technique, wherein content is targeted to a user based on a targeting algorithm and the targeted content is arranged on a page that is displayable by a computing device, comprising the steps of:
analyzing at least one algorithm of at least one targeting technique; and
altering an algorithm of at least one different targeting technique based on the analysis of the at least one algorithm of the at least one targeting technique.

73. A method for improving at least one content targeting technique, wherein content is targeted to a user based on a targeting algorithm and the targeted content is arranged on a page that is displayable by a computing device, comprising the steps of:
sharing, from a computing device of a first user, a content portion with a second user;
analyzing the sharing of the content portion with the second user; and
altering an algorithm of at least one targeting technique directed to the first user, based on the analysis of the sharing of the content portion.

74. The system according to claim 27, further comprising:
means for tracking user activity on the computing device; and
means for updating the selection of at least one of the categories based on the user activity.

75. The system according to claim 74, further comprising:
mean for suggesting an altered list of categories based on user activity.

76. The system according to claim 74, wherein the selection of at least one of the categories is updated to include at least a topic related to the user activity.

77. The system according to claim 74, wherein the selection of at least one of the categories is updated to remove at least a topic related to the user activity.

78. The system according to claim 74, wherein the user activity includes a purchase.

79. The system according to claim 27, wherein a percentage of the selected advertising content is selected to be random, and a percentage of the selected advertising content is not selected at random.

80. The system according to claim 27, further comprising:
mean for selecting different advertising content from the database that corresponds to a different targeting technique; and
mean for transmitting the page including the selected different advertising content to the computing device for display on the computing device.

81. The system according to claim 27, further comprising:
mean for displaying a list of topics related to demographic information;
mean for receiving a selection of at least one of the topics of demographic information from the user; and
mean for updating the selection of at least one categories based on receiving the selection of the at least one of the topics of demographic information.

82. The system according to claim 74, further comprising:
mean for inferring behavioral information from the user activity.

83. The system according to claim 82, wherein the behavioral information includes contextual information.

84. The system according to claim 82, the means for inferring comprising:
means for identifying at least one of keyword metadata of a page that is visited by a user on the computing device, keywords located in the content loaded into the page visited by the user on the computing device, and the domain of the page visited by the user on the computing device.

85. The system according to claim 27, further comprising:
mean for receiving a shared content portion from a second user;
mean for tracking actions by the user on the shared content portion; and
mean for updating the selection of the at least one of the categories stored in the database to reflect the actions by the user on the shared content portion.

86. The system according to claim 27, further comprising:
mean for receiving a shared content portion from a second user; and
mean for updating the selection of the at least one of the categories stored the database, to reflect information related to the shared content portion.

87. A system for improving at least one content targeting technique, wherein content is targeted to a user based on a targeting algorithm and the targeted content is arranged on a page that is displayable by a computing device, comprising the steps of:
mean for displaying a list of categories of available advertising content, wherein the available advertising content is stored in a database;
mean for receiving a selection of at least one of the categories of the advertising content from a user;
mean for analyzing the selection of at least one of the categories; and
mean for altering an algorithm at least one targeting technique based on the analysis of the selection of at least one of the categories.

88. A system for improving at least one content targeting technique, wherein content is targeted to a user based on a targeting algorithm and the targeted content is arranged on a page that is displayable by a computing device, comprising the steps of:
mean for receiving a shared content portion from a first user at a computing device of a second user;
mean for analyzing the receiving of the shared content portion; and
mean for altering an algorithm of at least one targeting technique directed to the second user, based on the analysis of the receiving of the shared content portion.

89. A system for improving at least one content targeting technique, wherein content is targeted to a user based on a targeting algorithm and the targeted content is arranged on a page that is displayable by a computing device, comprising the steps of:
mean for analyzing at least one algorithm of at least one targeting technique; and
mean for altering an algorithm of at least one different targeting technique based on the analysis of the at least one algorithm of the at least one targeting technique.

90. A system for improving at least one content targeting technique, wherein content is targeted to a user based on a targeting algorithm and the targeted content is arranged on a page that is displayable by a computing device, comprising the steps of:
mean for sharing, from a computing device of a first user, a content portion with a second user;
mean for analyzing the sharing of the content portion with the second user; and
mean for altering an algorithm of at least one targeting technique directed to the first user, based on the analysis of the sharing of the content portion.
